(19) United States
(12) Patent Application Publication
(10) Pub. No.: US 2026/0332359 A1
(43) Pub. Date: Oct. 22, 2026

(54) METHOD PERFORMED BY TERMINAL AND BASE STATION IN WIRELESS COMMUNICATION SYSTEM

(71) Applicant: Samsung Electronics Co., Ltd., Gyeonggi-do (KR)

(72) Inventors: Min WU, Beijing (CN); Feifei SUN, Beijing (CN)

(21) Appl. No.: 19/113,229

(22) PCT Filed: Sep. 27, 2023
(86) PCT No.: PCT/KR2023/014952

§ 371 Date: Mar. 19, 2025

(30) Foreign Application Priority Data
Sep. 28, 2022 (CN) 202211194379.5
Nov. 11, 2022 (CN) 202211415695.0

(51) Int. Cl. H04L 5/00; H04W 72/23; H04W 72/51; H04W 74/0833

(52) U.S. Cl. CPC H04L 5/0094; H04W 72/23; H04W 72/51; H04W 74/0833

(57) ABSTRACT

The disclosure relates to a 5G or 6G communication system for supporting a higher data transmission rate. A method performed by a user equipment (UE) in a wireless communication system is provided. The method comprises receiving, from a base station, first information on a location of a first sub-band in a bandwidth part (BWP), receiving, from the base station, second information on at least one resource for a data channel in the first sub-band and identifying a location of the at least one resource for the data channel based on the first information and the second information.

### TECHNICAL FIELD

The present disclosure relates to a wireless communication system, and more specifically, a method performed by a terminal and a base station in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

A method performed by a user equipment (UE) in a wireless communication system is provided. The method comprises receiving, from a base station, first information on a location of a first sub-band in a bandwidth part (BWP), receiving, from the base station, second information on at least one resource for a data channel in the first sub-band and identifying a location of the at least one resource for the data channel based on the first information and the second information.

A user equipment (UE) in a wireless communication system is provided. The UE comprises a transceiver and a controller coupled with the transceiver and configured to receive, from a base station, first information on a location of a first sub-band in a bandwidth part (BWP), receive, from the base station, second information on at least one resource for a data channel in the first sub-band, and identify a location of the at least one resource for the data channel based on the first information and the second information.

A method performed by a base station in a wireless communication system is provided. The method comprises transmitting, to a user equipment (UE), first information on a location of a first sub-band in a bandwidth part (BWP); and transmitting, to the UE, second information on at least one resource for a data channel in the first sub-band. A location of the at least one resource for the data channel is associated with the first information and the second information.

A base station in a wireless communication system is provided. The base station comprises a transceiver; and a controller coupled with the transceiver and configured to transmit, to a user equipment (UE), first information on a location of a first sub-band in a bandwidth part (BWP), and transmit, to the UE, second information on at least one resource for a data channel in the first sub-band. A location of the at least one resource for the data channel is associated with the first information and the second information.

### BRIEF DESCRIPTION OF DRAWINGS

The proposed system and method are illustrated in the accompanying drawings, throughout which like reference letters indicate corresponding parts in the various figures. The embodiments herein will be better understood from the following description with reference to the drawings, in which:

FIG. 1 is an example wireless network according to various embodiments of the present application;

FIG. 2A illustrates example wireless transmission and reception paths according to an embodiment

FIG. 2B illustrates example wireless transmission and reception paths according to an embodiment;

FIG. 3A is an example UE according to an embodiment;

FIG. 3B is an example gNB according to an embodiment;

FIG. 4 is a schematic flowchart of a method executed by a UE according to an embodiment;

FIG. 5 is a BWP division scheme in an example according to an embodiment;

FIG. 6 is another BWP division scheme in an example according to an embodiment;

FIG. 7 is still another BWP division scheme in an example according to an embodiment;

FIG. 8 is yet another BWP division scheme in an example according to an embodiment;

FIG. 9 is a schematic structure diagram of an electronic device according to an embodiment;

FIG. 10 illustrates a structure of a UE according to an embodiment of the disclosure; and

FIG. 11 illustrates a structure of a base station according to an embodiment of the disclosure.

### BEST MODE FOR CARRYING OUT THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In a Rel-17 NR system, a reduced capability (RedCap) UE has been proposed. The Redcap UE technology is to satisfy the requirements of specific application scenarios, and achieve the requirements of reducing cost and power consumption by reducing the terminal's air interface capability and the complexity. The Redcap UE is mainly directed to an Internet of Things (IoT) scenario because the IoT scenario requires terminal complexity and cost reduction, size reduction, lower energy consumption, etc. In general, the RedCap UE has the following characteristics: the terminal complexity is reduced, and the complexity and cost are lower compared with high-end eMBBs and URLLC terminals; the device size is smaller, so that the requirements for compact design are satisfied; and, it can be deployed in the 5G full band, including support TDD and FDD modes. The transmission bandwidth of the RedCap UE is limited within a 20 MHz bandwidth. In addition, the number of receiving antennas and the number of layers are decreased, and the scheduling bandwidth of data channels (PDSCHs and PUSCHs) is further limited to 5 MHz. Therefore, the present application provides a scheduling enhancement scheme.

An objective of the present application is to solve at least one of the above technical defects. The embodiments of the present application employ the following technical solutions.

In accordance with one aspect of the embodiments of the present application, a method executed by a user equipment (UE) is provided, including:
receiving related information of a frequency-domain location of a first sub-band in a bandwidth part (BWP);
receiving frequency-domain resource allocation information of a data channel in the first sub-band; and
determining the frequency-domain resource location of the data channel based on the related information of the frequency-domain location of the first sub-band and the frequency-domain resource allocation information of the data channel.

Optionally, the receiving related information of a frequency-domain location of a first sub-band in a bandwidth part (BWP) includes at least one of the following:
receiving a radio resource control (RRC) signaling or a medium access control (MAC) control element (CE) signaling, the RRC signaling or the MAC CE signaling containing frequency-domain location indication information of the first sub-band in the BWP;
receiving an RRC signaling or an MAC CE signaling, the RRC signaling or the MAC CE signaling containing sub-band index indication information of the first sub-band in the BWP; and

receiving downlink control information (DCI), the DCI containing sub-band index indication information of the first sub-band in the BWP;
wherein the sub-band index indication information is used to indicate one sub-band from a plurality of sub-bands.

Optionally, the frequency-domain location indication information of the first sub-band in the BWP contained in the RRC signaling or the MAC CE signaling is indicated based on a Type 0 resource allocation method or a Type 1 resource allocation method.

Optionally, the plurality of sub-bands are obtained by dividing the BWP based on a predefined rule, or the plurality of sub-bands are configured based on an RRC signaling.

Optionally, the plurality of sub-bands being preconfigured through an RRC signaling includes:

the plurality of sub-bands are configured based on the Type 0 resource allocation method or Type 1 resource allocation method through the RRC signaling.

Optionally, the plurality of sub-bands being obtained by dividing the BWP based on a predefined rule includes at least one of the following:
the plurality of sub-bands are obtained by dividing the BWP in by first division scheme, wherein physical resource blocks (PRBs) in the plurality of sub-bands are continuous; and
the plurality of sub-bands are obtained by dividing the BWP by a second division scheme, wherein PRBs in the plurality of sub-bands are discrete.

Optionally, the plurality of sub-bands being obtained by dividing the BWP by a first division scheme includes at least one of the following:
the BWP is divided from a PRB with the lowest frequency domain using a division granularity of N PRBs to obtain └M/N┘ sub-bands; and
the BWP is divided from a PRB with the lowest frequency domain using a division granularity of 1 PRB to obtain M−N+1 sub-bands.

Wherein, M is the number of PRBs included in the BWP, N is the number N of PRBs included in the sub-band, and └M/N┘ represents that the M is divided by the N and then rounded down.

Optionally, the BWP being divided from a PRB with the lowest frequency domain using a division granularity of N PRBs to obtain └M/N┘ sub-bands includes:
if the M cannot be exactly divided by the N, the BWP is divided from a PRB with the lowest frequency domain using a division granularity of N PRBs to obtain └M/N┘ sub-bands, and then the BWP is divided from a PRB with the highest frequency domain using a division granularity of N PRBs to obtain other └M/N┘ sub-bands, so that total 2*└M/N┘ sub-bands are obtained.

Optionally, the plurality of sub-bands being obtained by dividing the BWP by a second division scheme includes:
PRBs in the BWP are allocated to different sub-bands one by one from a PRB with the lowest frequency domain to obtain └M/N┘ sub-bands;
wherein, M is the number of PRBs included in the BWP, N is the number N of PRBs included in the sub-band, and └M/N┘ represents that the M is divided by the N and then rounded down.

Optionally, the DCI and the data channel scheduled by the DCI satisfy a minimum gap in time, where the value of the minimum gap is predefined, or determined by the UE's capability; and/or
the resource earliest schedulable by the DCI is a first time unit after the DCI.

Optionally, the receiving frequency-domain resource allocation information of a data channel in the first sub-band includes:
receiving DCI, the DCI containing the frequency-domain resource allocation information of the data channel in the first sub-band, the frequency-domain resource allocation information being indicated based on the Type 0 resource allocation method or the Type 1 resource allocation method.

Optionally, the frequency-domain resource allocation information being indicated by the Type 0 resource allocation method includes:
it is indicated by a bit map that one or more resource block groups (RBGs) in the first sub-band are scheduled, so that the frequency-domain resource allocation information is indicated;
wherein the size of BRGs in the first sub-band is determined in at least one of the following ways:

determining the size of RBGs in the first sub-band based on the bandwidth of the BWP; and
determining the size of RBGs in the first sub-band based on the bandwidth of the first sub-band.

Optionally, the frequency-domain resource allocation information being indicated by the Type 1 resource allocation method includes:
the frequency-domain resource allocation information is indicated by indicating a starting virtual resource block (VRB) and continuously scheduled VRBs in the first sub-band, and the VRBs corresponding to the frequency-domain resource allocation information are mapped to PRBs;
wherein the VRBs are mapped to PRBs based on a distributed mapping rule if any one of the following conditions is satisfied:
the UE's capability supports the distributed mapping rule; and
the DCI and the data channel scheduled by the DCI are located in different time units.

Optionally, the method further includes:
determining a second sub-band after frequency hopping based on the first sub-band, if the data channel is configured as a frequency hopping mode; and
receiving or transmitting, based on the first sub-band and the second sub-band, the data channel for frequency hopping transmission.

Optionally, the determining a second sub-band after frequency hopping includes at least one of the following:
determining the sub-band index of the second sub-band based on the sub-band index of the first sub-band;
determining the second sub-band corresponding to the first sub-band based on an RRC signaling; and
determining the second sub-band corresponding to the first sub-band based on a DCI signaling.

Optionally, the method further includes:
monitoring a PDCCH for scheduling a PDSCH by using a dedicated search space or an RNTI value dedicated to the UE, the dedicated search space being different from a search space used by a legacy system UE to monitor the PDCCH, or the dedicated RNTI value being different from an RNTI value used by a legacy system UE to monitor the PDCCH.

Optionally, the dedicated search space includes at least one of the following:
a dedicated search space for monitoring and scheduling a paging message;
a dedicated search space for monitoring and scheduling system information; and
a dedicated search space for monitoring and scheduling a random access response.

Optionally, the dedicated RNTI value includes at least one of the following:
a dedicated paging-radio network temporary identity (P-RNTI) value for monitoring a PDCCH for scheduling a paging message; and
a dedicated system information-radio network temporary identity (SI-RNTI) value for monitoring a PDCCH for scheduling SIB1.

Optionally, the method further includes:
initiating a random access process on a dedicated PRACH resource, wherein the dedicated PRACH resource implicitly indicates to a base station that the UE is a second RedCap UE.

Optionally, the method further includes:
initiating a random access process by using the dedicated PRACH resource for the second RedCap UE, if the dedicated PRACH resource is configured;
initiating a random access process by using the dedicated PRACH resource for the first RedCap UE, if the dedicated PRACH resource for the second RedCap UE is not configured but the dedicated PRACH resource for the first RedCap UE is configured by the network; and
initiating a random access process by using a PRACH resource for a non-RedCap UE, if both the dedicated PRACH resource for the second RedCap UE and the dedicated PRACH resource for the first RedCap UE are not configured by the network.

Optionally, the method further includes:
configuring the dedicated PRACH resource as some PRACH resources in the dedicated PRACH resources for the first RedCap UE, the some PRACH resources being shared by the second RedCap UE and the first RedCap UE; and/or
configuring the dedicated PRACH resource as some PRACH resources in the PRACH resources for the non-RedCap UE, the some PRACH resources being shared by the second RedCap UE and the non-RedCap UE.

Optionally, the UE is prohibited from accessing a cell corresponding to the base station in any one of the following situations:
the base station indicates, by using a reserved bit in a physical broadcast channel (PBCH), that the UE is prohibited from accessing the cell;
the base station indicates, by using a reserved bit in DCI for scheduling a system information block (SIB1) PDSCH, that the UE is prohibited from accessing the cell;
a PDSCH for carrying SIB1 is allocated with a bandwidth that exceeds a first preset bandwidth value; and
a PDSCH for carrying RAR is allocated with a bandwidth that exceeds the first preset bandwidth value.

Optionally, when receiving a broadcast PDSCH with a bandwidth exceeding a second preset bandwidth value transmitted by the base station, the method further includes at least one of the following:
receiving a second preset number of PRBs with the lowest frequency domain in the broadcast PDSCH; and
receiving the broadcast PDSCH based on UE implementation.

Optionally, the method further includes:
reporting at least one of the following information to the base station:
whether the UE has a capability to receive a unicast PDSCH and a PBCH simultaneously, where the unicast PDSCH and the PBCH are overlapped partially or completely in time resources, or located in the same time unit, and the total bandwidth of the bandwidth where the unicast PDSCH is located and the bandwidth where the PBCH is located does not exceed a third preset bandwidth value or exceeds the third preset bandwidth value;
whether the UE has a capability to receive a unicast PDSCH and a broadcast PDSCH simultaneously, where the unicast PDSCH and the broadcast PDSCH are overlapped partially or completely in time resources, or located in the same time unit, and the total bandwidth of the bandwidth where the unicast PDSCH is located and the bandwidth where the broadcast PDSCH is located does not exceed the third preset bandwidth value or exceeds the third preset bandwidth value; and
whether the UE has a capability to receive at least two unicast PDSCHs simultaneously, where the at least two unicast PDSCHs are not overlapped in time resources, and located the same time unit, and the total bandwidth of the bandwidths where the at least two unicast PDSCHs are located does not exceed the third preset bandwidth value or exceeds the third preset bandwidth value.

Optionally, the method further includes:
preferentially receiving the unicast PDSC, if the UE does not have the capability to receive a unicast PDSCH and a PBCH simultaneously, or determining, based on the type of the unicast PDSCH, to preferentially receive one of the unicast PDSCH and the PBCH; and
preferentially receiving the unicast PDSCH, if the UE does not have the capability to receive a unicast PDSCH and a broadcast PDSCH simultaneously, or determining, based on the type of the unicast PDSCH, to preferentially receive one of the unicast PDSCH and the broadcast PDSCH.

Optionally, the determining, based on the type of the unicast PDSCH, to preferentially receive one of the unicast PDSCH and the PBCH includes:
preferentially receiving the unicast PDSCH, if the unicast PDSCH is based on dynamic scheduling; and
preferentially receiving the PBCH, if the unicast PDSCH is a semi-persistent scheduling PDSCH, or determining, based on UE implementation, to preferentially receive one of the unicast PDSCH and the PBCH.

Optionally, the determining, based on the type of the unicast PDSCH, to preferentially receive one of the unicast PDSCH and the broadcast PDSCH includes:
preferentially receiving the unicast PDSCH, if the unicast PDSCH is based on dynamic scheduling; and
preferentially receiving the broadcast PDSCH, if the unicast PDSCH is a semipersistent scheduling PDSCH, or determining, based on UE implementation, to preferentially receive one of the unicast PDSCH and the broadcast PDSCH.

In accordance with another aspect of the embodiments of the present application, a method executed by a base station is provided, including:
transmitting, to a user equipment (UE), related information of a frequency-domain location of a first sub-band in a bandwidth part (BWP);
transmitting a physical downlink control channel (PDCCH) to the UE, the PDCCH containing frequency-domain resource allocation information of a data channel in the first sub-band; and
transmitting the data channel scheduled by the PDCCH to the UE, the frequency-domain resource location of the data channel being determined based on the related information of the frequency-domain location of the first sub-band and the frequency-domain resource allocation information of the data channel.

Optionally, the transmitting, to a user equipment (UE), related information of a frequency-domain location of a first sub-band in a bandwidth part (BWP) includes at least one of the following:
transmitting a radio resource control (RRC) signaling or a medium access control (MAC) control element (CE) signaling to the UE, the RRC signaling or the MAC CE signaling containing frequency-domain location indication information of the first sub-band in the BWP;
transmitting an RRC signaling or an MAC CE signaling to the UE, the RRC signaling or the MAC CE signaling containing sub-band index indication information of the first sub-band in the BWP; and
transmitting downlink control information (DCI) to the UE, the DCI containing sub-band index indication information of the first sub-band in the BWP;
wherein the sub-band index indication information is used to indicate one sub-band from a plurality of sub-bands.

Optionally, the frequency-domain location indication information of the first sub-band in the BWP contained in the RRC signaling or the MAC CE signaling is indicated based on a Type 0 resource allocation method or a Type 1 resource allocation method.

Optionally, the plurality of sub-bands are obtained by dividing the BWP based on a predefined rule, or the plurality of sub-bands are configured through an RRC signaling.

Optionally, the plurality of sub-bands being preconfigured based on an RRC signaling includes:
the plurality of sub-bands are configured based on the Type 0 resource allocation method or Type 1 resource allocation method through the RRC signaling.

Optionally, the plurality of sub-bands being obtained by dividing the BWP based on a predefined rule includes at least one of the following:
the plurality of sub-bands are obtained by dividing the BWP by a first division scheme, wherein physical resource blocks (PRBs) in the plurality of sub-bands are continuous; and
the plurality of sub-bands are obtained by dividing the BWP by a second division scheme, wherein PRBs in the plurality of sub-bands are discrete.

Optionally, the plurality of sub-bands being obtained by dividing the BWP by a first division scheme includes at least one of the following:
the BWP is divided from a PRB with the lowest frequency domain using a division granularity of N PRBs to obtain └M/N┘ sub-bands; and
the BWP is divided from a PRB with the lowest frequency domain using a division granularity of 1 PRB to obtain M−N+1 sub-bands;
wherein, M is the number of PRBs included in the BWP, N is the number N of PRBs included in the sub-band, and └M/N┘ represents that the M is divided by the N and then rounded down.

Optionally, the BWP being divided from a PRB with the lowest frequency domain using a division granularity of N PRBs to obtain └M/N┘ sub-bands includes:
if the M cannot be exactly divided by the N, the BWP is divided from a PRB with the lowest frequency domain using a division granularity of N PRBs to obtain └M/N┘ sub-bands, and then the BWP is divided from a PRB with the highest frequency domain using a division granularity of N PRBs to obtain other └M/N┘ sub-bands, so that total 2*└M/N┘ sub-bands are obtained.

Optionally, the plurality of sub-bands being obtained by dividing the BWP by a second division scheme includes:
PRBs in the BWP are allocated to different sub-bands one by one from a PRB with the lowest frequency domain to obtain └M/N┘ sub-bands;
Wherein, M is the number of PRBs included in the BWP, N is the number N of PRBs included in the sub-band, and └M/N┘ represents that the M is divided by the N and then rounded down.

Optionally, the DCI and the data channel scheduled by the DCI satisfy a minimum gap in time, where the value of the minimum gap is predefined, or determined by the UE's capability; and/or
the resource earliest schedulable by the DCI is a first time unit after the DCI.

Optionally, the transmitting a physical downlink control channel (PDCCH) to the UE, the PDCCH containing frequency-domain resource allocation information of a data channel in the first sub-band includes:
transmitting DCI to the UE, the DCI containing the frequency-domain resource allocation information of the data channel in the first sub-band, the frequency-domain resource allocation information being indicated based on the Type 0 resource allocation method or the Type 1 resource allocation method.

Optionally, the frequency-domain resource allocation information being indicated by the Type 0 resource allocation method includes:
it is indicated by a bit map that one or more resource block groups (RBGs) in the first sub-band are scheduled, so that the frequency-domain resource allocation information is indicated;
wherein the size of BRGs in the first sub-band is determined in at least one of the following ways:
determining the size of RBGs in the first sub-band based on the bandwidth of the BWP; and
determining the size of RBGs in the first sub-band based on the bandwidth of the first sub-band.

Optionally, the frequency-domain resource allocation information being indicated by the Type 1 resource allocation method includes:
the frequency-domain resource allocation information is indicated by indicating a starting virtual resource block (VRB) and continuously scheduled VRBs in the first sub-band, and the VRBs corresponding to the frequency-domain resource allocation information are mapped to PRBs;
wherein the VRBs are mapped to PRBs based on a distributed mapping rule if any one of the following conditions is satisfied:
the UE's capability supports the distributed mapping rule; and
the DCI and the data channel scheduled by the DCI are located in different time units.

Optionally, the method further includes:
transmitting, to the UE, a PDCCH for scheduling a broadcast physical downlink shared channel (PDSCH) by using a dedicated search space or a radio network temporary identity (RNTI) value dedicated to the UE, the dedicated search space being different from a search space used by a legacy system UE to monitor the PDCCH, or the dedicated RNTI value being different from an RNTI value used by a legacy system UE to monitor the PDCCH.

Optionally, the dedicated search space includes at least one of the following:
a dedicated search space for monitoring and scheduling a paging message;
a dedicated search space for monitoring and scheduling system information; and
a dedicated search space for monitoring and scheduling a random access response.

Optionally, the dedicated RNTI value includes at least one of the following:
a dedicated paging-radio network temporary identity (P-RNTI) value for monitoring a PDCCH for scheduling a paging message; and
a dedicated system information-radio network temporary identity (SI-RNTI) value for monitoring a PDCCH for scheduling SIB1.

Optionally, the method further includes:
receiving a random access process initiated by the UE on a dedicated physical random access channel (PRACH) resource, and determining the UE as a second reduced capability (RedCap) UE.

Optionally, the method further includes:
receiving a random access process initiated by the UE on the dedicated PRACH resource, if the dedicated PRACH resource is configured;
receiving a random access process initiated by the UE on the dedicated PRACH resource for the first RedCap UE, if the dedicated PRACH resource is not configured but the network is configured with a dedicated PRACH resource for a first RedCap UE; and
receiving a random access process initiated by the UE on a PRACH resource for a non-RedCap UE, if the dedicated PRACH resource is not configured and the network is configured with no dedicated PRACH resource for the first RedCap UE.

Optionally, the method further includes:
configuring the dedicated PRACH resource as some PRACH resources in the dedicated PRACH resources for the first RedCap UE, the some PRACH resources being shared by the second RedCap UE and the first RedCap UE; and/or
configuring the dedicated PRACH resource as some PRACH resources in the PRACH resources for the non-RedCap UE, the some PRACH resources being shared by the second RedCap UE and the non-RedCap UE.

Optionally, the UE is prohibited from accessing a cell corresponding to the base station in any one of the following situations:
the base station indicates, by using a reserved bit in a physical broadcast channel (PBCH), that the UE is prohibited from accessing the cell;
the base station indicates, by using a reserved bit in DCI for scheduling a system information block (SIB1) PDSCH, that the UE is prohibited from accessing the cell;
a PDSCH for carrying SIB1 is allocated with a bandwidth that exceeds a first preset bandwidth value; and
a PDSCH for carrying RAR is allocated with a bandwidth that exceeds the first preset bandwidth value.

Optionally, the method further includes:
receiving at least one of the following information reported by the UE:
whether the UE has a capability to receive a unicast PDSCH and a PBCH simultaneously, where the unicast PDSCH and the PBCH are overlapped partially or completely in time resources, or located in the same time unit, and the total bandwidth of the bandwidth where the unicast PDSCH is located and the bandwidth where the PBCH is located does not exceed a third preset bandwidth value or exceeds the third preset bandwidth value;
whether the UE has a capability to receive a unicast PDSCH and a broadcast PDSCH simultaneously, where the unicast PDSCH and the broadcast PDSCH are overlapped partially or completely in time resources, or located in the same time unit, and the total bandwidth of the bandwidth where the unicast PDSCH is located and the bandwidth where the broadcast PDSCH is located does not exceed the third preset bandwidth value or exceeds the third preset bandwidth value; and
whether the UE has a capability to receive at least two unicast PDSCHs simultaneously, where the at least two unicast PDSCHs are not overlapped in time resources, and located in the same time unit, and the total bandwidth of the bandwidths where the at least two unicast PDSCHs are located does not exceed the third preset bandwidth value or exceeds the third preset bandwidth value.

In accordance with still another aspect of the embodiments of the present application, a user equipment (UE) is provided, including:
a transceiver; and
a processor, which is coupled to the transceiver and configured to control to execute the steps of the method executed by a UE provided by the present application.

In accordance with yet another aspect of the embodiments of the present application, a computer-readable storage medium is provided, the computer-readable storage medium having computer programs stored thereon that, when executed by a processor, implement the steps of the method executed by a UE provided in the present application.

In accordance with yet another aspect of the embodiments of the present application, a base station is provided, including:
a transceiver; and
a processor, which is coupled to the transceiver and configured to control to execute the steps of the method executed by a base station provided in the present application.

In accordance with yet another aspect of the embodiments of the present application, a computer program product is provided, including computer programs that, when executed by a processor, implement the steps of the method executed by a UE provided in the present application.

By the solutions provided by the present application, by configuring sub-bands for a data channel, the bandwidth of the data channel can be allowed to not exceed the baseband processing bandwidth of the UE, and the sub-bands for the data channel can be dynamically allocated within a bandwidth range of the BWP, that is, the data channel can be dynamically scheduled within a larger bandwidth range, thereby obtaining a selective diversity gain.

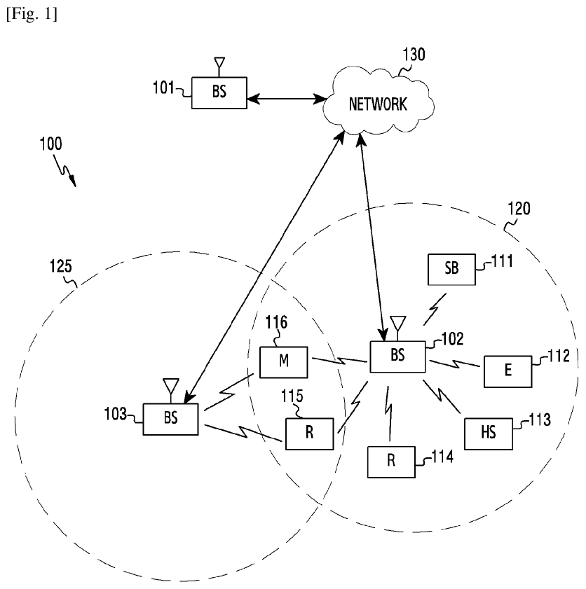

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. The gNB 101 communicates with the gNB 102 and gNB 103. The gNB 101 also communicates with at least one Internet Protocol (IP) network 130, such as the Internet, a private IP network, or other data network.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a plurality of first User Equipments (UEs) within a coverage area 120 of the gNB 102. The plurality of first UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to the network 130 for a plurality of second UEs within the coverage area 125 of the gNB 103. The plurality of second UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of a wireless network 100, it may make various changes to FIG. 1. For example, the wireless network 100 may include any number of gNBs and any number of UEs in any suitable arrangement. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

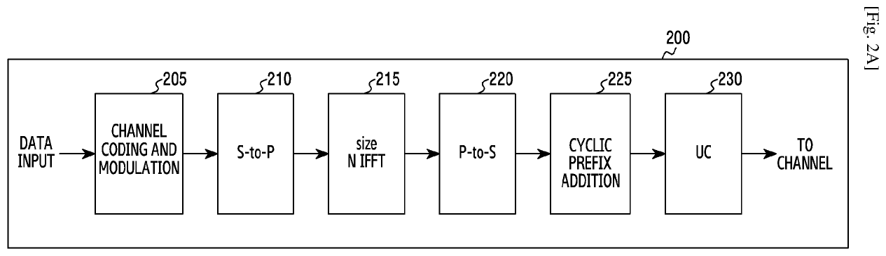

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

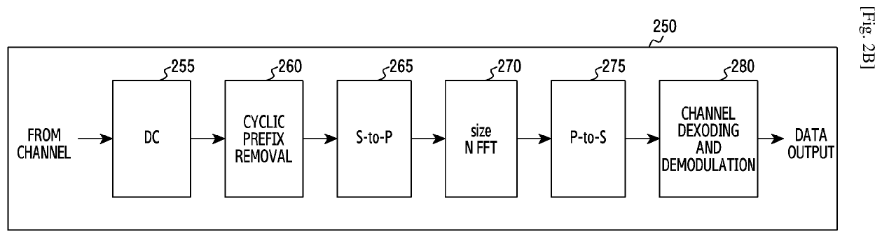

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface (IF) 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of a gNB 102, it may make various changes to FIG. 3B. For example, gNB 102 may include any number of respective components shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In the present disclosure, the Redcap UE is enhanced from aspects such as the frequency-domain resource allocation of PDSCHs/PUSCHs, the reception of broadcast PDSCHs, the random access and the UE's capability of simultaneously receiving a plurality of channels, and the aspects will be described below in detail.

It is to be noted that, in the present disclosure, the first Redcap UE may be a Rel-17 Redcap UE (or a Rel-17 version Redcap UE), and the second Redcap UE may be a Rel-18 RedCap UE (or Rel-18 version Redcap UE); however, it should be understood that the present disclosure is not limited thereto.

In addition, in the present disclosure, the sub-band may also be called a narrow-band, a scheduling bandwidth, a RedCap bandwidth, etc.

### Embodiment 1

In the existing new radio (NR) system, the frequency-domain resources for physical downlink shared channels (PDSCHs) and physical uplink shared channels (PUSCHs) are allocated based on the bandwidth part (BWP), and the UE is configured with at most 4 BWPs based on an RRC signaling. At a moment, one and only one BWP is activated, and the frequency-domain resources for PDSCHs/PUSCHs may be dynamically allocated within the bandwidth of the activated BWP. For a Rel-18 RedCap UE, in order to reduce the hardware cost, the baseband processing bandwidth of the data channels (PDSCHs/PUSCHs) of the UE is only 5 MHz. Correspondingly, the maximum number of scheduling physical resource blocks (PRBs) of PDSCHs and PUSCHs does not exceed 25 PRBs at a subcarrier spacing of 15 kHz and does not exceed 11 (or 12) PRBs at a subcarrier spacing of 30 kHz; however, the radio frequency (RF) bandwidth of the UE can be supported to 20 MHz at most. Therefore, in order to support the flexibility of scheduling, the BWP may be configured with 20 MHz, and the scheduling of PDSCHs and PUSCHs may be limited within a sub-band not exceeding 5 MHz within the 20 MHz bandwidth, which has an advantage that the PDSCHs and PUSCHs of the Rel-18 RedCap UE can be dynamically scheduled within a larger bandwidth (20 MHz), thereby obtaining a selective diversity gain by dynamic scheduling within a larger bandwidth.

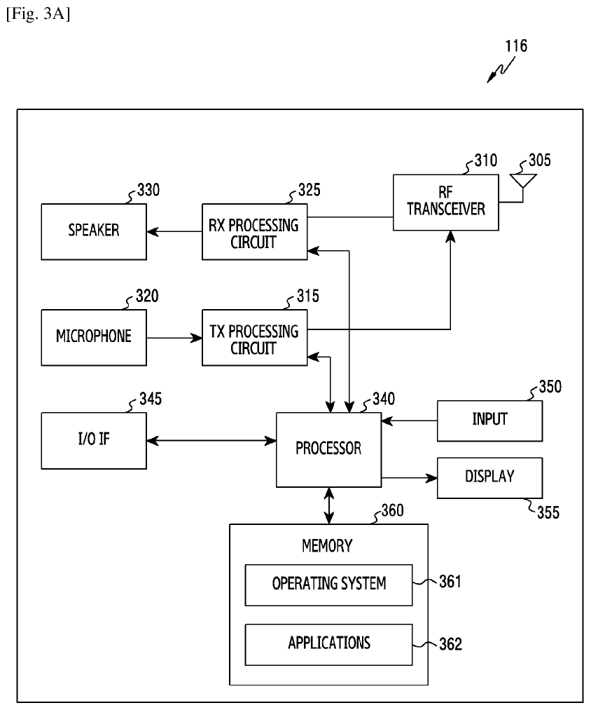

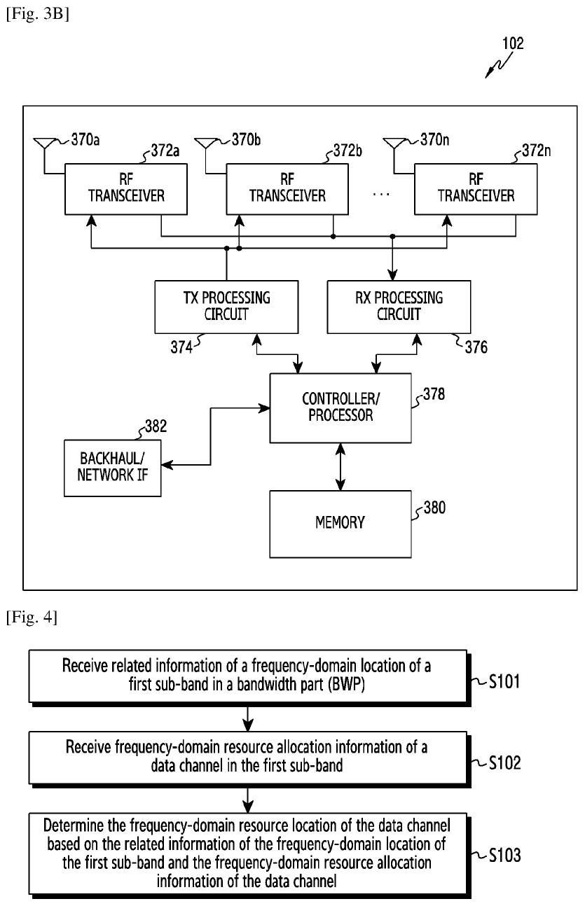

FIG. 4 is a schematic flowchart of a method executed by a UE according to an embodiment of the present disclosure.

As shown in FIG. 4, the method may include: in step S101, related information of a frequency-domain location of a first sub-band in a BWP is received; in step S102, frequency-domain resource allocation information of a data channel in the first sub-band is received; and in step S103, the frequency-domain resource location of the data channel is determined based on the related information of the frequency-domain location of the first sub-band and the frequency-domain resource allocation information of the data channel.

According to an embodiment, at step S101, the UE may receive related information on a frequency-domain location of a first sub-band in a bandwidth part (BWP) from the base station.

At step S102, the UE may receive frequency-domain resource allocation information of a data channel in the first sub-band from the base station.

At step S103, the UE may determine the frequency-domain resource location of the data channel based on the related information of the frequency-domain location of the first sub-band and the frequency-domain resource allocation information of the data channel.

Specifically, the UE acquires the frequency-domain location information of a sub-band (i.e., the first sub-band) in the BWP, and jointly determines the frequency-domain resource location of a PDSCH/PUSCH based on the frequency-domain location information of the sub-band and the frequency-domain resource allocation information of the data channel (PDSCH/PUSCH). Here, the frequency-domain resource allocation information of the PDSCH/PUSCH is indicated based on the sub-band. In other words, the frequency-domain resource for the PDSCH/PUSCH is allocated based on the subband, that is, the maximum bandwidth of the PDSCH/PUSCH does not exceed the bandwidth of the sub-band; and, the frequency-domain location of the sub-band is indicated based on the BWP, that is, the bandwidth of the sub-band is only part of the bandwidth of the BWP.

By the solutions provided by the present disclosure, by configuring sub-bands for a data channel, the bandwidth of the data channel can be allowed to not exceed the baseband processing bandwidth of the UE, and the sub-bands for the data channel can be dynamically allocated within a bandwidth range of the BWP, that is, the data channel can be dynamically scheduled within a larger bandwidth range, thereby obtaining a selective diversity gain.

In one optional embodiment of the present disclosure, the receiving related information of a frequency-domain location of a first sub-band in a BWP includes at least one of the following:
receiving a radio resource control (RRC) signaling or a medium access control (MAC) control element (CE) signaling, the RRC signaling or the MAC CE signaling containing frequency-domain location indication information of the first sub-band in the BWP;
receiving an RRC signaling or an MAC CE signaling, the RRC signaling or the MAC CE signaling containing sub-band index indication information of the first sub-band in the BWP; and
receiving downlink control information (DCI), the DCI containing sub-band index indication information of the first sub-band in the BWP;
wherein the sub-band index indication information is used to indicate one sub-band from a plurality of sub-bands.

Further, the frequency-domain location indication information of the first sub-band in the BWP contained in the RRC signaling or the MAC CE signaling is indicated based on a Type 0 resource allocation method or a Type 1 resource allocation method.

Further, the plurality of sub-bands are obtained by dividing the BWP based on a predefined rule, or the plurality of sub-bands are configured based on an RRC signaling.

The plurality of sub-bands being preconfigured based on an RRC signaling includes: the plurality of sub-bands are configured based on the Type 0 resource allocation method or Type 1 resource allocation method through the RRC signaling.

The data channel includes a PDSCH and a PUSCH.

Specifically, in one optional solution, the MAC CE signaling is that the frequency-domain location of the sub-band in the BWP is semi-statically configured. For example, it is indicated by an RRC signaling or an MAC CE signaling that the existing PDSCH/PUSCH resource allocation Type 0 or Type 1 method may be reused to configure the frequency-domain location of the sub-band in the BWP. The advantage of this method is that the UE can know the frequency-domain location of the sub-band in advance before receiving the physical downlink control channel (PDCCH), so that the signal of the corresponding frequency band can be buffered in advance without waiting for the decoding result of the PDCCH. Thus, scheduling in a time unit (or slot) can be supported (the PDCCH and the PDSCH scheduled by the PDCCH are in a same time unit (or slot)), and the scheduling delay is reduced. It is to be noted that, in various embodiments of the present disclosure, the time unit can be a slot, and the following description is given by slot.

In another optional solution, the frequency-domain location of the sub-band in the BWP is dynamically indicated, for example, being indicated by downlink control information (DCI). The frequency-domain location information of the sub-band in the BWP may be indicated by the scheduling DCI of the PDSCH/PUSCH. The scheduling DCI contains a special field for indicating the frequency-domain location of the sub-band in the BWP, or the frequency-domain information of the sub-band in the BWP and the resource allocation of the PDSCH/PUSCH in the sub-band are jointly indicated by a DCI domain. Here, the DCI may indicate one of a plurality of sub-bands. The frequency-domain locations of the plurality of sub-bands in the BWP may be predefined or preconfigured. For example, the BWP is divided into a plurality of subbands by a predefined rule. Or, the frequency-domain locations of the plurality of subbands are indicated based on an RRC signaling. For example, the frequency-domain location of a sub-band in the BWP is indicated by the existing PDSCH/PUSCH resource allocation Type 0 or Type 1 method. The advantage of this method is that the frequency-domain location of the sub-band can be dynamically adjusted to obtain a selective fading gain of the wireless channel. That is, the base station can always schedule the UE in the frequency band with better channel conditions according to the actual state of the wireless channel.

It is to be noted that the DCI and the data channel scheduled by the DCI satisfy a minimum gap in time, where the value of the minimum gap is predefined, or determined by the UE's capability; and/or, the resource earliest schedulable by the DCI is a first time unit after the DCI.

In the method of dynamically indicating the frequency-domain location of the sub-band in the BWP by DCI, intra-slot scheduling is not supported, and only cross-slot scheduling is supported. That is, the DCI and the PDSCH scheduled by the DCI cannot be in a same slot. In other words, the PDSCH resource earliest schedulable by the DCI is a first slot after the DCI. This is because, in cross-slot scheduling, the UE has enough time to decode the PDCCH before receiving the PDSCH and thus can buffer the baseband data signal of the PDSCH based on the frequency-domain location information of the PDSCH obtained by decoding the PDCCH; while in intra-slot scheduling, the UE does not have enough time to decode the PDCCH before receiving PDSCH, and thus cannot know the frequency-domain resource location information of the PDSCH and the frequency-domain location information of the 5 MHz sub-band, so that only the baseband data signal of the whole 20 MHz BWP can be buffered, which is not supported by the baseband capability of the Rel-18 RedCap UE. Or, the DCI and the PDSCH scheduled by the DCI should satisfy a minimum gap in time. That is, the PDSCH scheduled by the DCI should be located at a location satisfying the minimum gap after the DCI. The purpose of satisfying the minimum gap is to reserve enough time for the UE to decode the PDCCH, so that the UE buffers the baseband data signal of the PDSCH based on the frequency-domain location information of the PDSCH obtained by decoding the PDCCH. The value of the minimum gap may be predefined, or determined by the UE's capability. For example, the UE may report, to the base station, the supported minimum gap between the DCI and the PDSCH scheduled by the DCI, and the base station performs corresponding scheduling according to the UE's capability.

In the method of semi-statically configuring (e.g., configuring based on an RRC signaling or an MAC CE signaling) the frequency-domain location of the sub-band in the BWP, both intra-slot scheduling and cross-slot scheduling can be supported. In intra-slot scheduling, although the UE does not have enough time to decode the PDCCH before receiving the PDSCH and thus cannot know the frequency-domain resource location information of the PDSCH, the UE can know the frequency-domain location information of the 5 MHz sub-band and can buffer the baseband data signal of the 5 MHz sub-band first, which is supported by the baseband capability of the Rel-18 RedCap UE.

In one optional embodiment of the present disclosure, the plurality of sub-bands being obtained by dividing the BWP based on a predefined rule includes at least one of the following:
the plurality of sub-bands are obtained by dividing the BWP by a first division scheme, wherein physical resource blocks (PRBs) in the plurality of sub-bands are continuous; and
the plurality of sub-bands are obtained by dividing the BWP by a second division scheme, wherein PRBs in the plurality of sub-bands are discrete.

The first division scheme may also be called a localized division scheme, and the second division scheme may also be called a distributed division scheme.

Specifically, in the method of indicating the frequency-domain location of the sub-band in the BWP by DCI, the BWP may be divided into a plurality of sub-bands according to the predefined rule, and the scheduling DCI of the PDSCH/PUSCH indicates one of the plurality of sub-bands. Specifically, the BWP may be divided into a plurality of sub-bands by at least one of the following methods.

1. The whole BWP is divided into

$$⌊ {N}_{P R B}^{BWP} / {N}_{P R B}^{SB} ⌋$$

sub-bands from the PRB with the lowest frequency domain of the BWP, and the sub-bands are numbered from the low frequency, where

$${N}_{P R B}^{BWP}$$

is the number of PRBs contained in the BWP, and

$${N}_{P R B}^{SB}$$

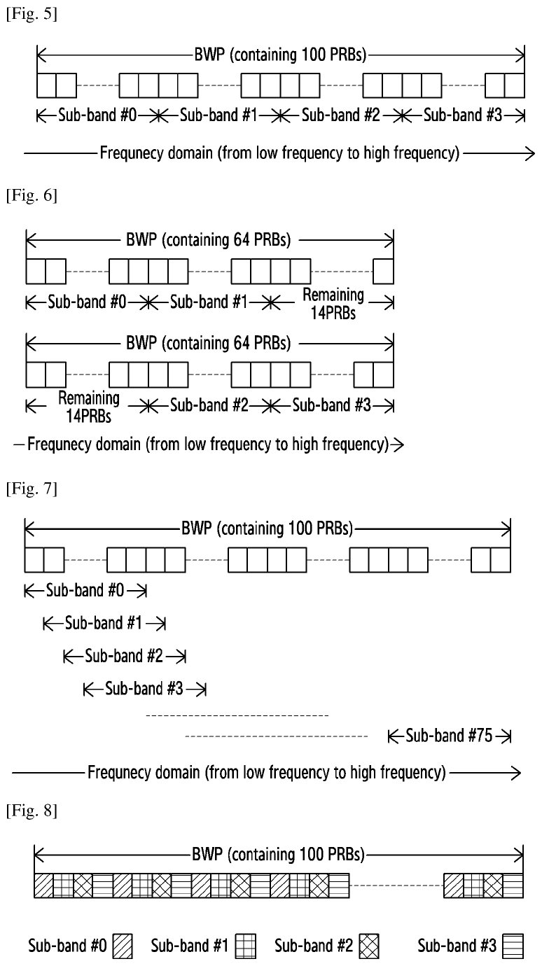

is the number of PRBs contained in a sub-band. As shown in FIG. 5, if it is assumed that the BWP contains 100 PRBs and a sub-band contain 25 BRPs, the BWP may be divided into 4 sub-bands, and the DCI may indicate one of the sub-bands by using 2 bits. Here, any two sub-bands are not overlapped, that is, they have no common PRB. In addition, when

$${N}_{P R B}^{BWP}$$

cannot be exactly divided by

$${N}_{P R B}^{SB} ,$$

since

$$⌊ {N}_{P R B}^{BWP} / {N}_{P R B}^{SB} ⌋$$

is rounded down, there may be some PRBs left at the upper end of the BWP that do not belong to any sub-band.

2. In order to associate each PRB in the BWP with one sub-band, when

$${N}_{P R B}^{BWP}$$

be exactly divided by

$${N}_{P R B}^{SB} ,$$

two division schemes of leaving low-frequency PRBs and high-frequency PRBs are supported, and the DCI indicates which division scheme to use or all sub-bands in the two division schemes are numbered. As shown in FIG. 6, if it is assumed that the BWP contains 64 PRBs and a sub-band contain 25 BRPs, there are 4 sub-bands in the two division schemes, and the DCI may indicate one of the subbands by using 2 bits. 14 PRBs are left in the two division schemes, that is, the first preset number is 14 at this time.

3. From the lowest PRB in the frequency domain of the BWP, each PRB may be used as the starting PRB of one sub-band, that is, sub-bands may slide by PRB in the BWP. As shown in FIG. 7, if it is assumed that the BWP contains 100 PRBs and a sub-band contains 25 PRBs, the BWP may be divided into 76 sub-bands.

4. The above methods 1, 2 and 3 can be regarded as allocating sub-bands in a localized manner (that is, the PRBs in the sub-bands are continuous). In order to support the distributed allocation of sub-bands in the BWP (that is, the PRBs in the sub-bands are discrete), the sub-bands may be divided as shown in FIG. 8. For example, PRBs are allocated to different scheduled sub-bands one by one. If it is assumed that the BWP contains 100 PRBs and a sub-band contains 25 PRBs, the index set of PRBs contained in the sub-band #0 is {0,4,8,12, . . . , 96}, the index set of PRBs contained in the sub-band #1 is {1,5,9,13, . . . , 97}, the index set of PRBs contained in the sub-band #2 is {2,6,10,14, . . . , 98}, and the index set of PRBs contained in the sub-band #3 is {3,7,11,115, . . . , 99}.

It is to be noted that, the sub-bands in the BWP can support both the localized division scheme (e.g., the above methods 1, 2 and 3) and the distributed division scheme (e.g., the above method 4), and the specific use of which division scheme can be preconfigured.

In the above embodiment, the UE acquires the frequency-domain location information of the first sub-band in the BWP. In addition to acquiring the frequency-domain location information of the sub-band in the BWP, the UE also needs to acquire the frequency-domain resource allocation information of the PDSCH/PUSCH in the sub-band. The frequency-domain resource allocation of the PDSCH/PUSCH in the sub-band can still adopt the Type 0 and Type 1 resource allocation methods.

In one optional embodiment of the present disclosure, the frequency-domain resource allocation information being indicated by the Type 0 resource allocation method includes:
it is indicated by a bit map that one or more resource block groups (RBGs) in the first sub-band are scheduled, so that the frequency-domain resource allocation information is indicated;
wherein the size of BRGs in the first sub-band is determined in at least one of the following ways:
determining the size of RBGs in the first sub-band based on the bandwidth of the BWP; and
determining the size of RBGs in the first sub-band based on the bandwidth of the first sub-band.

Specifically, in the Type 0 resource allocation method, it is indicated by a bit map that one or more RBGs in the sub-band are scheduled. Optionally, the size of RBGs in the sub-band (the number of PRBs contained in the RBGs) is determined according to the bandwidth of the sub-band, that is, the size of RBGs in the sub-band may be different from the size of RBGs in the BWP.

In the existing NR system, the size of RBGs (the number of contained PRBs) is related to the size of the BWP (the number of contained PRBs). Table 1 shows the size of RBGs when the size of the BWP is different.

| Size of the BWP | | |
|---|---|---|
| (the number of PRBs) | Configuration 1 | Configuration 2 |
| 1~36 | 2 | 4 |
| 37~72 | 4 | 8 |
| 73~144 | 8 | 16 |
| 145~275 | 16 | 16 |

For example, if it is assumed that the BWP contains 100 PRBs and a sub-band contains 25 PRBs, if the size of RBGs uses the configuration 2 in Table 1, the size of RBGs in the BWP is 16 PRBs, and the size of RBGs in the sub-band is 4 PRBs. In addition, the RBG division of the sub-band should ensure to have the same edge as the RBG in the BWP as far as possible. For example, the size of the first RBG in the sub-band meets

$$R B {G}_{0}^{size} = P - {N}_{SB , i}^{start}$$

mod P, the remaining PRBs are divided according to the size of RBGs, where P is the size of RBGs (i.e., division granularity), and

$${N}_{SB , i}^{start}$$

is the index number of the starting system resource block, which is also be called carrier resource block (CRB), of the sub-band, i.e., the index number of the resource block (RB) of the starting PRB of the sub-band in the system carrier bandwidth.

Or, the size of RBGs in the first sub-band is determined based on the size of RGBs in the BWP. The size of RBGs in the sub-band is determined according to the size of e BWP, that is, the size of RBGs in the sub-band is the same as the size of RBGs in the BWP. In addition, the RBG division in the sub-band should be consistent with the RBG division in the BWP.

In one optional embodiment of the present disclosure, the frequency-domain resource allocation information being indicated by the Type 1 resource allocation method includes:
the frequency-domain resource allocation information is indicated by indicating a starting virtual resource block (VRB) and continuously scheduled VRBs in the first sub-band, and the VRBs corresponding to the frequency-domain resource allocation information are mapped to PRBs;
wherein the VRBs are mapped to PRBs based on a distributed mapping rule if any one of the following conditions is satisfied:
the UE's capability supports the distributed mapping rule; and
the DCI and the data channel scheduled by the DCI are located in different time units.

Specifically, in the sub-band based Type 1 resource allocation method, the frequency-domain resource allocation is indicated by the starting VRB and the number of continuously scheduled VRBs in the sub-band, and the corresponding PRB location is then determined according to the mapping of VRBs to PRBs. The mapping of VRBs to PRBs can support localized mapping and distributed mapping, and the mapping mode and mapping rule of VRBs to PRBs should be the same as those of the mapping of VRBs to PRBs in the BWP.

The mapping mode of VRBs to PRBs in the Type 1 resource allocation of the Rel-18 RedCap UE is related to the following conditions.

1. The mapping mode of VRBs to PRBs is determined based on the UE's capability, that is, whether to support the distributed mapping of VRBs to PRBs is related to the UE's capability. The Rel-18 RedCap UE should report, to the base station, whether to support the distributed mapping.

2. During scheduling in the same slot (the PDCCH and the data channel scheduled by the PDCCH are in the same slot), the localized mapping of VRBs to PRBs is used by default; and, during cross-slot scheduling (the PDCCH and the data channel scheduled by the PDCCH are in different slots), the distributed mapping of VRBs to PRBs is used by default.

In one optional embodiment of the present disclosure, the method may further include:
determining a second sub-band after frequency hopping based on the first sub-band, if the data channel is configured as a frequency hopping mode; and
receiving or transmitting, based on the first sub-band and the second sub-band, the data channel for frequency hopping transmission.

Further, the determining a second sub-band after frequency hopping includes at least one of the following:
determining the sub-band index of the second sub-band based on the sub-band index of the first sub-band;
determining the second sub-band corresponding to the first sub-band based on an RRC signaling; and
determining the second sub-band corresponding to the first sub-band based on a DCI signaling.

Specifically, for the Rel-18 RedCap UE, in order to obtain the frequency diversity gain, frequency hopping within 20 MHz can be supported, and the gap between the frequency-domain location before frequency hopping and the frequency-domain location after frequency hopping can exceed 5 MHz. In the above sub-band based frequency-domain resource allocation method, frequency hopping can be based on the sub-band, that is, the UE needs to determine the sub-band after frequency hopping and the frequency-domain resource of the sub-band. It is assumed that the sub-band before frequency hopping is called a first sub-band, and the sub-band after frequency hopping is called a second sub-band. The frequency-domain resource allocation in the first sub-band and the frequency-domain resource allocation in the second sub-band can be identical. During the execution of frequency hopping, the UE only needs to determine the second sub-band. The UE can determine the second sub-band according to any one of the following methods.

1. The second sub-band is determined based on the predefined rule. For example, the index number of the second sub-band is determined according to the formula Index₂=(Index₁+└N/2┘) mod N, where Index₁ is the index number of the second subband, Index₂ is the index number of the first sub-band, and N is the total number of sub-bands contained in the BWP.

2. The sub-band is determined based on the information preconfigured based on an RRC signaling, that is, the base station configures a corresponding frequency hopping sub-band for each sub-band. For example, the index number of the second sub-band is indicated based on the relative offset of the index number of the first sub-band, or two sub-bands are configured in pair for frequency hopping.

3. The second sub-band is determined based on the indication information in the scheduling DCI, that is, the second sub-band is indicated by the scheduling DCI.

Optionally, for the R-18 Redcap UE, the data channel may reuse the frequency-domain resource allocation method of the legacy system (the allocation method in the above embodiment may become the sub-band based frequency-domain resource allocation method), that is, the frequency-domain resource allocation is indicated based on the BWP. Due to its low hardware processing capability, the R-18 Redcap UE can only buffer the data signal within 5 MHz, and should know the frequency-domain resource allocation of the PDSCH before receiving the PDSCH. Therefore, the PDSCH does not support the scheduling in the same slot (the PDCCH and the PDSCH scheduled by the PDCCH are in the same slot), and can only support cross-slot scheduling (the PDCCH and the PDSCH scheduled by the PDCCH are in different slots).

Optionally, for the R-18 Redcap UE, a unicast data channel can reuse the frequency-domain resource allocation method of the legacy system, that is, the frequency-domain resource allocation is indicated based on the BWP. Unlike legacy UEs (UEs in the legacy system), the R-18 Redcap UE does not expect to receive a PDCCH indicating the scheduling bandwidth of the data channel exceeds 5 MHz. The scheduling bandwidth of the data channel exceeding 5 MHz means that the scheduling bandwidth of the data channel exceeds 25 PRBs at a subcarrier spacing of 15 kHz and exceeds 11 or 12 PRBs at a subcarrier spacing of 30 kHz. Or, when the UE receives a PDCCH indicating that the scheduling width of the data channel exceeds 5 MHz, the UE executes any one of the following behaviors.

1. The UE determines that the received scheduling information is invalid, and will not perform any corresponding transmission or reception.

2. The UE receives or transmits some data signals within 5 MHz of the data channel, i.e., receiving or transmitting data signals of 25 PRBs (corresponding to a subcarrier spacing of 15 kHz) or 11 PRBs (corresponding to a subcarrier spacing of 30 kHz) within the scheduling bandwidth. The location of the 25 PRBs or 11 PRBs may be predefined, for example, first 25 PRBs or 11 PRBs from the low-frequency PRB within the scheduling bandwidth; or, the location of the 25 PRBs or 11 PRBs are determined by UE implementation.

3. It is determined, based on the UE's capability, whether the received scheduling information is wrong. For example, whether it is able to receive or transmit some data signals within 5 MHz of the data channel having a scheduling bandwidth exceeding 5 MHz is a UE's capability. If the UE does not have this capability, the UE should determine that the received scheduling information is invalid; and, if the UE has this capability, the UE receives or transmits some data signals within 5 MHz of the data channel.

It is to be noted that, for the Rel-18 RedCap UE, both the sub-band based frequency-domain resource allocation method and the reuse of the frequency-domain resource allocation method of the legacy system are supported. The specific use of which frequency-domain resource allocation method may be determined in the following ways.

1. It is configured based on an RRC signaling or indicated in the scheduling DCI, which has an advantage of providing enough flexibility for base station configuration.

2. For a broadcast data channel, the frequency-domain resource allocation method of the legacy method is reused, which has an advantage that it can better coexist with UEs of the legacy system; while for a unicast data channel, the sub-band frequency-domain resource allocation method is used, which has an advantage that the downlink control signaling overhead for the Rel-18 RedCap UE is saved.

3. The use of which frequency-domain resource allocation method depends upon the UE's capability. For example, the UE reports, to the base station, whether to support the frequency-domain resource allocation method of the legacy system, and/or the UE reports, to the base station, whether to support the sub-band based frequency-domain resource allocation method; and, the base station uses an appropriate frequency-domain resource allocation method according to the UE's capability.

4. During scheduling in the same slot (the PDCCH and the data channel scheduled by the PDCCH are in the same slot), the sub-band based frequency-domain resource allocation method is used by default; and, during cross-slot scheduling (the PDCCH and the data channel scheduled by the PDCCH are in different slots), the frequency-domain resource allocation method of the legacy system is reused by default.

5. For a PDSCH, the sub-band based frequency-domain resource allocation method is used, which has an advantage of saving the downlink control signaling overhead; while for a PUSCH, the frequency-domain resource allocation method of the legacy system is reused, which has an advantage of supporting enough scheduling flexibility.

### Embodiment 2

Since the scheduling bandwidth of the PDSCH of the Rel-18 RedCap UE cannot exceed 5 MHz, the coexistence of the Rel-18 RedCap UE and the legacy UE will be affected. For example, if the base station expects that the two UE receive a same broadcast PDSCH, the scheduling bandwidth of the broadcast PDSCH should be limited within 5 MHz, which will affect the performance of the legacy UE. Therefore, the base station may transmit respective broadcast PDSCHs to the two UEs, that is, the Rel-18 RedCap UE and the legacy UE receives the respective PDSCHs. For example, the two UEs monitor PDCCHs for scheduling broadcast PDSCHs by using respective PDCCH search spaces or RNTI values. Here, the broadcast PDSCH may be a PDSCH for carrying a paging message, a PDSCH for carrying system information, or a PDSCH for carrying a random access response (RAR) (e.g., Msg2 in the random access process).

In one optional embodiment of the present disclosure, the method further includes:
monitoring a PDCCH for scheduling a PDSCH by using a dedicated search space or an RNTI value dedicated to the UE, the dedicated search space being different from a search space used by a legacy system UE to monitor the PDCCH, or the dedicated RNTI value being different from an RNTI value used by a legacy system UE to monitor the PDCCH.

The dedicated search space includes at least one of the following:
a dedicated search space for monitoring and scheduling a paging message;
a dedicated search space for monitoring and scheduling system information; and
a dedicated search space for monitoring and scheduling a random access response.

The dedicated RNTI value includes at least one of the following:
a dedicated paging-radio network temporary identity (P-RNTI) value for monitoring a PDCCH for scheduling a paging message; and
a dedicated system information-radio network temporary identity (SI-RNTI) value for monitoring a PDCCH for scheduling SIB1.

Specifically, the base station configures, for the Rel-18 RedCap UE, a dedicated search space for the broadcast PDSCH. This search space is different from the search space of the legacy UE. For example, the base station may configure, for the Rel-18 RedCap UE, at least one of the following dedicated search spaces for scheduling the broadcast PDSCH.

1. The base station configures, for the Rel-18 RedCap UE, a dedicated search space for monitoring a paging message, which is different from the search space used by the legacy UE to monitor the paging message. For example, a new configuration pagingSearchSpace-R18-RedCap different from the existing configuration pagingSearchSpace is introduced.

2. The base station configures, for the Rel-18 RedCap UE, a dedicated search space for monitoring system information, which is different from the search space used by the legacy UE to monitor the system information. For example, a new configuration searchSpaceSIB1-R18-RedCap different from the existing configuration searchSpaceSIB1 is introduced, and/or a new configuration searchSpaceOtherSystemInformation-R18-RedCap different from the existing configuration searchSpaceOtherSystemInformation is introduced.

3. The base station configures, for the Rel-18 RedCap UE, a dedicated search space for monitoring a random access response, which is different from the search space used by the legacy UE to monitor the random access response. For example, a new configuration ra-SearchSpace-R18-RedCap different from the existing configuration raSearchSpace is introduced.

Optionally, the Rel-18 RedCap UE uses a P-RNTI value different from the existing P-RNTI to monitor a PDCCH for scheduling a paging message. For example, in the current NR system, the P-RNTI value is fixed as “FFFE” (hexadecimal), while the P-RNTI value used by the Rel-18 Redcap may be specified as “FFFD” or other predefined values.

Optionally, the Rel-18 RedCap UE uses an SI-RNTI value different from the existing SI-RNTI to monitor a PDCCH for scheduling SIB1. For example, in the current NR system, the SI-RNTI value is fixed as “FFFF” (hexadecimal), while the SI-RNTI value used by the Rel-18 Redcap may be specified as “FFFD” or other predefined values.

### Embodiment 3

Since the Rel-18 RedCap UE cannot receive a PDSCH exceeding the 5 MHz bandwidth and/or cannot transmit a PUSCH exceeding the 5 MHz bandwidth, the initial access process will be affected to a certain extent. If the UE cannot inform, in the first step (Msg1) of the random access process, the base station that it is a Rel-18 RedCap UE, the base station may schedule a PDSCH exceeding the 5 MHz bandwidth in the second step (Msg2) and the fourth step (Msg4) of the random access process, and the base station may also schedule a PUSCH exceeding the 5 MHz bandwidth in the third step (Msg3) of the random access process, so that the UE cannot receive the Msg2 and Msg4 and also cannot transmit the Msg3. Therefore, the Rel-18 RedCap UE should inform the base station in Msg1 that it is a Rel-18 RedCap UE, so that the Rel-18 RedCap UE can smoothly access the network. A direct way for the Rel-18 RedCap UE to inform the base station in Msg1 that it is a Rel-18 RedCap UE is to configure a dedicated PRACH resource, that is, the Rel-18 RedCap UE and the legacy UE are distinguished by grouping a PRACH resource pool.

In one optional embodiment of the present disclosure, the method further includes:
initiating a random access process on a dedicated PRACH resource, wherein the dedicated PRACH resource implicitly indicates to a base station that the UE is a second RedCap UE.

The first RedCap UE may be a Rel-18 RedCap UE, the second RedCap UE may be a Rel-17 RedCap UE, and the non-RedCap UE may be a legacy UE.

Further, the method may further include:
initiating a random access process by using the dedicated PRACH resource for the second RedCap UE, if the dedicated PRACH resource is configured;
initiating a random access process by using the dedicated PRACH resource for the first RedCap UE, if the dedicated PRACH resource for the second RedCap UE is not configured but the dedicated PRACH resource for the first RedCap UE is configured by the network; and
initiating a random access process by using a PRACH resource for a non-RedCap UE, if both the dedicated PRACH resource for the second RedCap UE and the dedicated PRACH resource for the first RedCap UE are not configured by the network.

Specifically, in a Rel-17 NR system, the base station has support the dedicated PRACH resource configured for the Rel-17 RedCap UE. Similarly, the base station may also configure a dedicated PRACH resource for the Rel-18 RedCap UE. In order to support the flexibility of the network, this configuration is optional. Since the configuration of dedicated PRACH resource pools for the Rel-17 RedCap UE and the Rel-18 RedCap UE will affect the PRACH capacity for the non-RedCap UE and the access performance of the non-RedCap UE, the base station may determine, according to the actual situation of the network, whether to configure dedicated PRACH pools for the Rel-17 RedCap UE and the Rel-18 RedCap UE. The Rel-18 RedCap UE may preferentially use the dedicated PRACH resource configured for the Rel-18 RedCap UE. If the base station does not configure the dedicated PRACH resource for the Rel-18 RedCap UE, the Rel-18 RedCap UE preferentially uses the dedicated PRACH resource configured for the Rel-17 RedCap UE; and, if the base station also does not configure the dedicated PRACH resource for the Rel-17 RedCap UE, the Rel-18 RedCap UE uses the PRACH resource configured for the non-RedCap UE.

Optionally, when the Rel-18 RedCap UE initiates a random access process, if the network is configured with PRACH resources dedicated to the Rel-18 RedCap UE, the UE selects a resource from the PRACH resources dedicated to the Rel-18 RedCap UE to initiate the random access process; if the network is configured with no PRACH resource dedicated to the Rel-18 RedCap UE but is configured with PRACH resources dedicated to the Rel-17 RedCap UE, the UE selects a resource from the PRACH resources dedicated to the Rel-17 RedCap UE to initiate the random access process; and, if the network is configured with no PRACH resource dedicated to the Rel-18 RedCap UE and no PRACH resource dedicated to the Rel-17 RedCap UE, the UE selects a resource from the PRACH resources for the non-RedCap UE to initiate the random access process.

Further, the method may further include:
configuring the dedicated PRACH resource as some PRACH resources in the dedicated PRACH resources for the first RedCap UE, the some PRACH resources being shared by the second RedCap UE and the first RedCap UE; and/or
configuring the dedicated PRACH resource as some PRACH resources in the PRACH resources for the non-RedCap UE, the some PRACH resources being shared by the second RedCap UE and the non-RedCap UE.

Specifically, in order to avoid the PRACH resources dedicated to the Rel-18 RedCap UE from affecting the PRACH capacity for the non-RedCap UE (or the Rel-17 RedCap UE), some PRACH resources in the PRACH resources for the non-RedCap UE (or the Rel-17 RedCap UE) may be configured as being available by the Rel-18 RedCap UE, that is, the some PRACH resources are shared by the Rel-18 RedCap UE and the non-RedCap UE (or the Rel-17 RedCap UE), while other PRACH resources are unavailable by the Rel-18 RedCap UE. The advantage is that the PRACH capacity for the non-RedCap UE (or the Rel-17 RedCap UE) will not be affected, and the random access performance of the non-RedCap UE (or the Rel-17 RedCap UE) is affected on only some shared PRACH resources. The base station may indicate some ROs in the PRACH resources for the non-RedCap UE (or the Rel-17 RedCap UE) as being sharable by the Rel-18 RedCap UE. For example, one RO in every N ROs is sharable by the Rel-18 RedCap UE, where N is configurable.

In one optional embodiment of the present disclosure, the UE is prohibited from accessing a cell corresponding to the base station in any one of the following situations:
the base station indicates, by using a reserved bit in a physical broadcast channel (PBCH), that the UE is prohibited from accessing the cell;
the base station indicates, by using a reserved bit in DCI for scheduling a system information block (SIB1) PDSCH, that the UE is prohibited from accessing the cell;
a PDSCH for carrying SIB1 is allocated with a bandwidth that exceeds a first preset bandwidth value; and
a PDSCH for carrying RAR is allocated with a bandwidth that exceeds the first preset bandwidth value.

Specifically, serving the Rel-18 RedCap UE may affect the random access performance of the non-RedCap UE and will also make the scheduling algorithm on the base station side more complicated. Therefore, in some cases, the base station expects to prohibit the Rel-18 RedCap UE from accessing the served cell. Specifically, the Rel-18 RedCap UE may be prohibited from accessing the cell by any one of the following methods.

1. A cell explicitly indicates, by a signaling, that the Rel-18 RedCap UE is prohibited from accessing this cell. For example, the base station indicates, by using a reserved bit in a PBCH, whether the Rel-18 RedCap UE is prohibited from accessing this cell, or the base station indicates, by using a reserved bit in DCI for scheduling an SIB1 PDSCH, whether the Rel-18 RedCap UE is prohibited from accessing this cell.

2. It is implicitly indicated by some scheduling that the Rel-18 RedCap UE is prohibited from accessing this cell. For example, if the PDSCH for carrying SIB1 is allocated with a bandwidth exceeding 5 MHz, it is implicitly indicated that the Rel-18 RedCap UE is prohibited from accessing this cell; and, if the PDSCH for carrying SIB1 is allocated with a bandwidth not exceeding 5 MHz, it is implicitly indicated that the Rel-18 RedCap UE is allowed to access this cell. Or, if the PDSCH for carrying RAR is allocated with a bandwidth exceeding 5 MHz, it is implicitly indicated that the Rel-18 RedCap UE is prohibited from accessing this cell; and, if the PDSCH for carrying RAR is allocated with a bandwidth not exceeding 5 MHz, it is implicitly indicated that the Rel-18 RedCap UE is allowed to access this cell.

### Embodiment 4

In one optional embodiment of the present disclosure, when receiving a broadcast PDSCH with a bandwidth exceeding a second preset bandwidth value transmitted by the base station, the method further includes at least one of the following:
receiving a second preset number of PRBs with the lowest frequency domain in the broadcast PDSCH; and
receiving the broadcast PDSCH based on UE implementation.

Specifically, the Rel-18 RedCap UE may receive some data signals within 5 MHz of a broadcast PDSCH with a scheduling bandwidth exceeding 5 MHz (corresponding to the second preset bandwidth value). For example, if the scheduling bandwidth of the broadcast PDSCH exceeds 5 MHz (exceeding 25 PRBs (corresponding to the second preset number of PRBs) at a subcarrier spacing of 15 kHz, and exceeding 11 or 12 PRBs (corresponding to the second preset number of PRBs at a subcarrier spacing of 30 kHz)), the UE may still receive the broadcast PDSCH. For example, in the case of 15 kHz, the UE receives only PDSCH signals on the lowest 25 PRBs of the broadcast PDSCH and discards PDSCH signals on other PRBs, and receives the broadcast PDSCH by trying to decode the truncated PDSCH signals. Or, which 25 PRBs the UE receives within the bandwidth of the broadcast PDSCH may depend upon the UE implementation.

### Embodiment 5

In the current NR system, the UE may receive a plurality of physical channels simultaneously. For example, the UE may receive a unicast channel and a broadcast channel simultaneously, or the UE may receive a plurality of unicast channels simultaneously. It is very difficult for the Rel-18 RedCap UE to realize the capability to receive a plurality of physical channels simultaneously, because the baseband modules of the Rel-18 RedCap UE are simplified. For example, the post-FFT data buffer, the receiving and processing mode, the LDPC decoding mode, the HARQ buffer or other modules are simplified, so the Rel-18 RedCap UE may be unable to receive a plurality of physical channels simultaneously. When a plurality of physical channels are allocated to a same symbol or slot, the UE needs to make a choice. In addition, since the receiving capability may be different after the baseband modules of the Rel-18 RedCap UE are simplified to a different extent, it is necessary for the UE to update the related capability, so that the base station provides appropriate scheduling according to the UE's capability.

In one optional embodiment of the present disclosure, the method may further include:
reporting, by the UE, at least one of the following information to the base station:
whether the UE has a capability to receive a unicast PDSCH and a PBCH simultaneously, where the unicast PDSCH and the PBCH are overlapped partially or completely in time resources, or located in the same slot, and the total bandwidth of the bandwidth where the unicast PDSCH is located and the bandwidth where the PBCH is located does not exceed a third preset bandwidth value or exceeds the third preset bandwidth value;
whether the UE has a capability to receive a unicast PDSCH and a broadcast PDSCH simultaneously, where the unicast PDSCH and the broadcast PDSCH are overlapped partially or completely in time resources, or located in the same slot, and the total bandwidth of the bandwidth where the unicast PDSCH is located and the bandwidth where the broadcast PDSCH is located does not exceed the third preset bandwidth value or exceeds the third preset bandwidth value; and
whether the UE has a capability to receive at least two unicast PDSCHs simultaneously, where the at least two unicast PDSCHs are not overlapped in time resources and are located in the same slot, and the total bandwidth of the bandwidths where the at least two unicast PDSCHs are located does not exceed the third preset bandwidth value or exceeds the third preset bandwidth value.

Specifically, in order to allow the base station to provide better scheduling and avoid a plurality of physical channels from being allocated to a same slot or symbol, the UE needs to report at least one of the following capabilities to the base station:
the UE reports, to the base station, whether it has a capability to receive a unicast PDSCH and a PBCH simultaneously, where the unicast PDSCH and the PBCH are overlapped partially or completely in time resources, or located in the same slot;
the UE reports, to the base station, whether it has a capability to receive a unicast PDSCH and a PBCH simultaneously, where the unicast PDSCH and the PBCH are overlapped partially or completely in time resources, or located in the same slot, and the total bandwidth of the bandwidth where the PDSCH is located and the bandwidth where the PBCH is located exceeds 5 MHz (corresponding to the third preset bandwidth value);
the UE reports, to the base station, whether it has a capability to receive a unicast PDSCH and a PBCH simultaneously, where the unicast PDSCH and the PBCH are overlapped partially or completely in time resources, or located in the same slot, and the total bandwidth of the bandwidth where the PDSCH is located and the bandwidth where the PBCH is located does not exceed 5 MHz (corresponding to the third preset bandwidth value);
the UE reports, to the base station, whether it has a capability to receive a unicast PDSCH and a broadcast PDSCH simultaneously, where the unicast PDSCH and the broadcast PDSCH are overlapped partially or completely in time resources, or located in the same slot;
the UE reports, to the base station, whether it has a capability to receive a unicast PDSCH and a broadcast PDSCH simultaneously, where the unicast PDSCH and the broadcast PDSCH are overlapped partially or completely in time resources, or located in the same slot, and the total bandwidth of the bandwidth where the unicast PDSCH is located and the bandwidth where the broadcast PDSCH is located exceeds 5 MHz (corresponding to the third preset bandwidth value);
the UE reports, to the base station, whether it has a capability to receive a unicast PDSCH and a broadcast PDSCH simultaneously, where the unicast PDSCH and the broadcast PDSCH are overlapped partially or completely in time resources, or located in the same slot, and the total bandwidth of the bandwidth where the unicast PDSCH is located and the bandwidth where the broadcast PDSCH is located does not exceed 5 MHz (corresponding to the third preset bandwidth value);
the UE reports, to the base station, whether it has a capability to receive two or more unicast PDSCHs simultaneously, where the two or more unicast PDSCHs are not overlapped in time resources and are located in the same slot;
the UE reports, to the base station, whether it has a capability to receive two or more unicast PDSCHs simultaneously, where the two or more unicast PDSCHs are not overlapped in time resources and are located in the same slot, and the total bandwidth of the bandwidths where the two or more unicast PDSCHs are located exceeds 5 MHz (corresponding to the third preset bandwidth value); and
the UE reports, to the base station, whether it has a capability to receive two or more unicast PDSCHs simultaneously, where the two or more unicast PDSCHs are not overlapped in time resources and are located in the same slot, and the total bandwidth of the bandwidths where the two or more unicast PDSCHs are located does not exceed 5 MHz (corresponding to the third preset bandwidth value).

It is to be noted that, in the foregoing description, the total bandwidth exceeding 5 MHz means that the total bandwidth exceeds 25 PRBs in the case of 15 kHz, and exceeds 11 or 12 PRBs in the case of 30 kHz; and, the total bandwidth doing not exceed 5 MHz means that the total bandwidth does not exceed 25 PRBs in the case of 15 kHz, and does not exceed 11 or 12 PRBs in the case of 30 kHz.

In one optional embodiment of the present disclosure, the method may further include:
preferentially receiving the unicast PDSC, if the UE does not have the capability to receive a unicast PDSCH and a PBCH simultaneously, or determining, based on the type of the unicast PDSCH, to preferentially receive one of the unicast PDSCH and the PBCH; and
preferentially receiving the unicast PDSCH, if the UE does not have the capability to receive a unicast PDSCH and a broadcast PDSCH simultaneously, or determining, based on the type of the unicast PDSCH, to preferentially receive one of the unicast PDSCH and the broadcast PDSCH.

Further, the determining, based on the type of the unicast PDSCH, to preferentially receive one of the unicast PDSCH and the PBCH includes:
preferentially receiving the unicast PDSCH, if the unicast PDSCH is based on dynamic scheduling; and
preferentially receiving the PBCH, if the unicast PDSCH is a semi-persistent scheduling PDSCH, or determining, based on UE implementation, to preferentially receive one of the unicast PDSCH and the PBCH.

Further, the determining, based on the type of the unicast PDSCH, to preferentially receive one of the unicast PDSCH and the broadcast PDSCH includes:
preferentially receiving the unicast PDSCH, if the unicast PDSCH is based on dynamic scheduling; and
preferentially receiving the broadcast PDSCH, if the unicast PDSCH is a semipersistent scheduling PDSCH, or determining, based on UE implementation, to preferentially receive one of the unicast PDSCH and the broadcast PDSCH.

Specifically, optionally, the UE does not have the capability to receive a unicast PDSCH and a PBCH simultaneously. If the unicast PDSCH and the PBCH are overlapped partially or completely in time resources or located in the same slot, the UE preferentially receives the unicast PDSCH.

Optionally, the UE does not have the capability to receive a unicast PDSCH and a PBCH simultaneously. If the unicast PDSCH and the PBCH are overlapped partially or completely in time resources or located in the same slot, the UE determines, according to the type of the unicast PDSCH, to preferentially receive one of the unicast PDSCH and the PBCH. For example, if the unicast PDSCH is based on dynamic scheduling, the UE preferentially receives the unicast PDSCH; and, if the unicast PDSCH is a semi-persistent (SPS) PDSCH, the UE preferentially receives the PBCH, or the UE receives one of the SPS PDSCH and the PDCH according to the UE implementation.

Optionally, the UE does not have the capability to receive a unicast PDSCH and a broadcast PDSCH simultaneously. If the unicast PDSCH and the broadcast PDSCH are overlapped partially or completely in time resources or located in the same slot, the UE preferentially receives the unicast PDSCH.

Optionally, the UE does not have the capability to receive a unicast PDSCH and a broadcast PDSCH simultaneously. If the unicast PDSCH and the broadcast PDSCH are overlapped partially or completely in time resources or located in the same slot, the UE determines, according to the type of the unicast PDSCH, to preferentially receive one of the unicast PDSCH and the broadcast PDSCH. For example, if the unicast PDSCH is based on dynamic scheduling, the UE preferentially receives the unicast PDSCH; and, if the unicast PDSCH is an SPS PDSCH, the UE preferentially receives the broadcast PDSCH, or the UE receives one of the SPS PDSCH and the broadcast PDSCH according to the UE implementation.

In one optional solution, for a Redcap UE, the maximum bandwidth that can be received by RF is 20 MHz, the maximum bandwidth that can be processed by baseband is 5 MHz, and the maximum bandwidth that can be buffered by the post-FFT buffer at the receiver may be 5 MHz or 20 MHz. Or, the maximum bandwidth that can be buffered by the post-FFT buffer being 20 MHz is only applicable to some OFDM symbols in a slot; while on other OFDM symbols in the slot, the maximum bandwidth that can be buffered by the post-FFT buffer is 5 MHz. If the maximum bandwidth that can be buffered by the post-FFT buffer at the receiver of the UE is 5 MHz, the base station should use cross-slot scheduling, to ensure that the UE can decode the PDCCH to know the scheduling information of the PDSCH before receiving the PDSCH, thereby buffering corresponding frequency band signals, without buffering all 20 MHz signals. That is, the capability of the post-FFT buffer at the receiver of the UE will affect the scheduling of the base station. Therefore, the Redcap UE needs to report at least one of the following related to the capability of the post-FFT buffer to the base station.
The UE indicates, to the base station, the maximum bandwidth that can be buffered by the post-FFT buffer.

The standard specification can predefine one or more values for the maximum bandwidth that can be buffered by the post-FFT buffer. The UE indicates, to the base station, that the maximum bandwidth that can be buffered by the post-FFT buffer meets a predefined value, or the maximum bandwidth that can be buffered by the post-FFT buffer is one of a plurality of predefined values. For example, the predefined value of the maximum bandwidth that can be buffered by the post-FFT buffer may be 5 MHz, 10 MHz or 20 MHz.
The UE indicates the size of the post-FFT buffer to the base station.

The standard specification can predefine one or more values for the size of the post-FFT buffer of the UE. The UE indicates, to the base station, that the size of the post-FFT buffer meets a predefined value, or the size of the post-FFT buffer is one of a plurality of predefined values. For example, for 15 kHz, buffering 20 MHz signals of one OFDM symbol is buffering 100 PRBs, i.e., buffering signals on 1200 resource elements (REs). If it is assumed that the post-FFT buffer is emptied after one slot at the latest, the post-FFT buffer needs to be able to buffer 14 (for a conventional CP) OFDM symbols simultaneously, and the corresponding size of the post-FFT buffer is 14*1200=16800 REs. The predefined value of the size of the post-FFT buffer may be 16800 REs, 8400 REs or 4200 REs, or the predefined value of the size of the post-FFT buffer may be 1400 PRBs, 700 PRBs or 350 RRBs.
The UE indicates the relative size of the post-FFT buffer to the base station.

The standard specification can predefine one or more values for the relative size of the post-FFT buffer of the UE. The UE indicates, to the base station, that the relative size of the post-FFT buffer meets a predefined value, or the relative size of the post-FFT buffer is one of a plurality of predefined values. For example, by using the size of the buffer for buffering 20 MHz bandwidth as a reference value, the predefined relative size may be 1, 0.5, 0.25, etc. 0.5 means that the size of the post-FFT value is half of the reference value, and 0.25 means the size of the post-FFT buffer is a quarter of the reference value.
The UE indicates, to the base station, the maximum number of OFDM symbols of 20 MHz signals that can be buffered by the post-FFT buffer in a slot.

The standard specification can predefine one or more values for the maximum number of OFDM symbols of 20 MHz signals that can be buffered by the post-FFT buffer of the UE in a slot. The UE indicates, to the base station, that the maximum number of OFDM symbols of 20 MHz signals that can be buffered by the post-FFT buffer in a slot meets a predefined value, or the maximum number of OFDM symbols of 20 MHz signals that can be buffered by the post-FFT buffer in a slot is one of a plurality of predefined values. For example, the predefined value of the maximum number of OFDM symbols of 20 MHz signals that can be buffered by the post-FFT buffer in a slot may be 14, 7 or 3 OFDM symbols.

In one optional solution, for a Redcap UE, the maximum bandwidth that can be received by RF is 20 MHz, and the maximum bandwidth that can be processed by baseband is 5 MHz. If the scheduling bandwidth of the PDSCH is larger than 5 MHz, the baseband of the UE may process different frequency band signals of the PDSCH in different time respectively. For example, if the scheduling bandwidth of the PDSCH is 10 MHz, the baseband of the UE may process the PDSCH in two periods of time, where 5 MHz signals of the PDSCH at a low frequency location are processed in a first period of time, and 5 MHz signals of the PDSCH at a high frequency location are processed in a second period of time. Compared with the receiving and processing method where only 5 MHz signals of the PDSCH are process, this receiving and processing method can greatly improve the decoding performance of the PDSCH. Since the receiving and processing time of the PDSCH will be prolonged by processing different frequency band signals in different time respectively, the UE cannot receive and process other PDSCHs in a period of time after the PDSCH. This baseband receiving and processing method will affect the PDSCH receiving capability and thus affect the scheduling of the base station, so this Redcap UE needs to report at least one of the following related to the PDSCH receiving capability to the base station:
The UE indicates, to the base station, whether the baseband module at the receiver has the capability to process different frequency band signals of the PDSCH in different time respectively.

Here, the PDSCH may be a unicast PDSCH and/or a broadcast PDSCH. In addition, the UE may also indicate whether it has this capability for different subcarrier spacings, respectively. For example, the UE indicates whether it has this capability for 15 kHz, 30 kHz, 60 kHz and/or 120 kHz, respectively. If the UE has this capability, the base station may transmit, to the UE, a PDSCH with a scheduling bandwidth larger than 5 MHz. When the scheduling bandwidth of the PDSCH is 5 to 10 MHz, since the maximum baseband processing bandwidth of the UE is 5 MHz, the baseband of the UE may process different frequency band signals of the PDSCH in two periods of time, respectively; when the scheduling bandwidth of the PDSCH is 10 to 15 MHz, the baseband of the UE may process different frequency band signals of the PDSCH in three periods of time, respectively; and, when the scheduling bandwidth of the PDSCH is 15 to 20 MHz, the baseband of the UE may process different frequency band signals of the PDSCH in four periods of time, respectively.
The UE indicates, to the base station, the maximum scheduling bandwidth of the PDSCH that can be received and processed.

Here, the PDSCH may be a unicast PDSCH and/or a broadcast PDSCH. The standard specification can predefine one or more values for the maximum bandwidth of the PDSCH that can be received and processed by the UE. The UE indicates, to the base station, that the maximum scheduling bandwidth of the PDSCH that can be received and processed meets a predefined value, or the maximum scheduling bandwidth of the PDSCH that can be received and processed is one of a plurality of predefined values. For example, the predefined value of the maximum scheduling bandwidth of the PDSCH that can be received and processed by the UE may be 5 MHz, 10 MHz or 20 MHz. In addition, the UE may also indicate the corresponding maximum scheduling width of the PDSCH for different subcarrier spacings, respectively. For example, the UE indicates the corresponding maximum scheduling bandwidth of the PDSCH for 15 kHz, 30 kHz, 60 kHz and/or 120 kHz, respectively. The scheduling bandwidth of the PDSCH transmitted to the UE by the base station should not exceed the capability reported by the UE.
The UE indicates, to the base station, the minimum time gap between two PDSCHs corresponding to different transport blocks received in a slot or two continuous slots.

Here, the two PDSCHs means two unicast PDSCHs, two broadcast PDSCHs, or a unicast PDSCH and a broadcast PDSCH. The time gap between the two PDSCHs means the relative gap between the ending (last) OFDM symbol of the first PDSCH and the starting (first) OFDM symbol of the second PDSCH. The unit of the gap may be OFDM symbol. For example, the minimum gap between two PDSCHs may be 2, 3, 4, 7, 10 or 14 OFDM symbols. In addition, the UE may also indicate the corresponding minimum gap between two PDSCHs for different subcarrier spacings, respectively. For example, the UE indicates the corresponding minimum gap between two PDSCHs for 15 kHz, 30 kHz, 60 kHz and/or 120 kHz, respectively. The gap between two continuous PDSCHs transmitted to the UE by the base station should not exceed the capability reported by the UE.
The UE indicates, to the base station, the maximum number of PDSCHs corresponding to different transport blocks that can be received and processed in a slot.

Here, the PDSCHs may be unicast PDSCHs and/or broadcast PDSCHs. The maximum number of PDSCHs may be 1, 2, 4 or 7. In addition, the UE may also indicate the corresponding maximum number of PDSCHs for different subcarrier spacings, respectively. For example, the UE indicates the corresponding maximum number of PDSCHs for 15 kHz, 30 kHz, 60 kHz and/or 120 kHz, respectively. The number of PDSCHs transmitted to the UE by the base station in a slot should not exceed the capability reported by the UE.
The UE indicates, to the base station, the maximum total number of mapped PRBs of the PDSCH that can be received and processed.

Here, the PDSCH may be a unicast PDSCH and/or a broadcast PDSCH, and the total number of mapped PRBs means the total number of PRBs of the PDSCH mapped in a duration (one or more OFDM symbols) of the time domain. In addition, the UE may also indicate the corresponding maximum total number of mapped PRBs of the PDSCH for different subcarrier spacings, respectively. For example, the UE indicates the corresponding maximum total number of mapped PRBs of the PDSCH for 15 kHz, 30 kHz, 60 kHz and/or 120 kHz, respectively. The maximum total number of mapped PRBs of the PDSCH transmitted to the UE by the base station should not exceed the capability reported by the UE.

In one optional solution, for a Redcap UE, the PDCCH receiving capability may be further extended based on the existing UE's capability. For example, the minimum time gap between two PDCCHs received by the UE is represented by (X, Y), where X is the number of continuous OFDM symbols of the PDCCH in time domain, and Y is the minimum number of OFDM symbols in the gap between two PDCCHs. The gap between two PDCCHs means the relative gap between starting OFDM symbols of two PDCCHs. In addition, the value of Y should be larger than or equal to X. In the existing standard specification, the existing value of (X, Y) may be (2,2), (3,4) or (3,7). For a Redcap UE, the value of (X, Y) may be further extended as (1,2), (2,3), (2,4), etc.

For a Redcap UE, the maximum bandwidth that can be received by RF is 20 MHz, and the maximum bandwidth that can be processed by baseband is 5 MHz. If the scheduling bandwidth of the PDSCH is larger than 5 MHz, the baseband of the UE may process different frequency band signals of the PDSCH in different time respectively. This method of processing different frequency band signals in different time respectively will significantly prolong the receiving and processing time of the PDSCH, and will affect some time lines of the existing time. For example, the prolonged receiving and processing time of the PDSCH, the HARQ feedback of the PDSCH needs to be delayed. In addition, if the PDSCH is a PDSCH for scheduling a new data transmission, the DRC inactivity timer (drx-inactivityTimer) started after the scheduled PDCCH corresponding to the PDSCH also needs to be delayed.

In one optional solution, in order to solve the problem that the receiving and processing time of the PDSCH is significantly prolonged, the HARQ feedback of the PDSCH is transmitted after delaying a first offset based on the existing time line. For example, the UE transmits the corresponding HARQ feedback in a first uplink slot satisfying the k+Offset_1 gap after the PDSCH, where k is the existing feedback delay, the unit of the k is slot, and the value of the k may be indicated by an HARQ feedback time indication field in the corresponding scheduling DCI of the PDSCH, or the value of the k is configured through a higher-layer signaling; and, Offset_1 is the first offset, and the unit of the first offset may be slot or OFDM symbol. For example, for a PDSCH for scheduling a new data transmission, the UE starts the drx-inactivityTimer at the first OFDM symbol satisfying a second offset after the scheduled PDCCH corresponding to the PDSCH, where the unit of the second offset is OFDM symbol.

The value of the first offset and/or the value of the second offset may be predefined, or preconfigured by the base station through a higher-layer signaling, or reported by the UE; or, the value of the first offset and/or the value of the second offset are determined by the scheduling bandwidth of the PDSCH. For example, the scheduling bandwidth of the PDSCH is 5 to 10 MHz, the value of the first offset or the value of the second offset is v; when the scheduling bandwidth of the PDSCH is 10 to 15 MHz, the value of the first offset or the value of the second offset is 2*v; and, when the scheduling bandwidth of the PDSCH is 15 to 20 MHz, the value of the first offset or the value of the second offset is 3*v, where the value of the parameter v may be predefined, or preconfigured by the base station through a higher-layer signaling, or reported by the UE. Or, under different scheduling bandwidths of the PDSCH, the value of the first offset and/or the value of the second offset may be predefined or preconfigured, respectively.

In addition, whether the UE applies the first offset and/or the second offset for the time line may be determined by at least one of the following conditions.
The UE reports, to the base station, that it is a predefined Redcap UE type. That is, only the Redcap UE of the predefined type can apply the first offset and/or the second offset.
When the scheduling bandwidth of the PDSCH is larger than a preset value, for example, only when the scheduling bandwidth of the PDSCH is larger than 5 MHz or 10 MHz, the UE applies the first offset and/or the second offset.
The UE applying the first offset and/or the second offset is configured by the base station. That is, the UE applies the first offset and/or the second offset only after it receives the corresponding configuration signaling. For example, the base station configures, based on an RRC signaling, that the UE applies the first offset and/or the second offset, or the base station indicates, in the scheduling DCI of the PDSCH, whether the UE applies the first offset and/or the second offset for the PDSCH.

In one optional solution, for a Redcap UE, the maximum bandwidth that can be received by RF is 20 MHz, and the maximum bandwidth that can be processed by baseband is 5 MHz. If the scheduling bandwidth of the PDSCH is larger than 5 MHz, the baseband of the UE may process different frequency band signals of the PDSCH in different time respectively. The UE does not expect to receive another PDSCH carrying a different transport block in a period of time after this PDSCH, no matter whether the anther PDSCH is a unicast PDSCH or a broadcast PDSCH. For example, the UE does not expect to receive another PDSCH in a Gap time after this PDSCH. Similar to the above first offset or second offset, the value of Gap may be predefined, or preconfigured by the base station through a higher-layer signaling, or reported by the UE; or, the value of Gap is related to the scheduling bandwidth of the PDSCH. For example, under different scheduling bandwidths of the PDSCH, the corresponding value of Gap may be predefined, or preconfigured by the base station through a higher-layer signaling, or reported by the UE.

In an optional solution, for a Redcap UE, the maximum bandwidth that can be received by RF is 20 MHz, and the maximum bandwidth that can be processed by baseband is 5 MHz. If the scheduling bandwidth of the PDSCH is larger than 5 MHz, the baseband of the UE may process different frequency band signals of the PDSCH in different time respectively. If the UE receives another PDSCH carrying a different transport block in a period of time after this PDSCH, the UE may execute at least one of the following behaviors:
The subsequent processing of this PDSCH is ended. That is, only some frequency band signals of this PDSCH are received and processed, while some frequency band signals of this PDSCH are discarded, so that the baseband processing unit is vacated for processing a next PDSCH.
Other frequency band signals of this PDSCH are continuously processed, and the processing of a next PDSCH is discarded or delayed.
The UE determines, accord he priorities of two PDSCHs, whether to terminal the subsequent processing of a previous PDSCH. For example, the priority of the previous PDSCH is not lower than or higher than that of the next PDSCH, the UE continuously receives and processes other frequency signals of the previous PDSCH, and discards or delays the processing of the next PDSCH; and, if the priority of the previous PDSCH is not higher than or lower than that that of the next PDSCH, the UE ends the subsequent processing of the previous PDSCH, and starts to process the next PDSCH, wherein the priority of the PDSCH may be indicated in the corresponding scheduling DCI, and/or it is stipulated that a unicast PDSCH has a higher priority than a broadcast PDSCH, and/or it is stipulated that a dynamic scheduling PDSCH has a higher priority than a semipersistent PDSCH.

### Embodiment 6

An embodiment of the present disclosure provides a schematic flowchart of a method executed by a base station. The method may include the following steps: in step S201, related information of a frequency-domain location of a first sub-band in a BWP is transmitted to a UE; in step S202, a PDCCH is transmitted to the UE, the PDCCH containing frequency-domain resource allocation information of a data channel in the first sub-band; and, in step S203, the data channel scheduled by the PDCCH is transmitted to the UE, the frequency-domain resource location of the data channel being determined based on the related information of the frequency-domain location of the first sub-band and the frequency-domain resource allocation information of the data channel.

Similarly, the method provided in the embodiment of the present disclosure corresponds to the method in the embodiments on the UE side, and the detailed functional descriptions and the achieved beneficial effects can specifically refer to the above descriptions of the corresponding method in the embodiments on the UE side and will not be repeated here.

### Embodiment 7

An embodiment of the present disclosure further provides an electronic device, including a memory, a processor and computer programs stored on the memory, wherein the processor, when executing the computer programs, can implement the steps in the method provided in any one optional embodiment of the present disclosure.

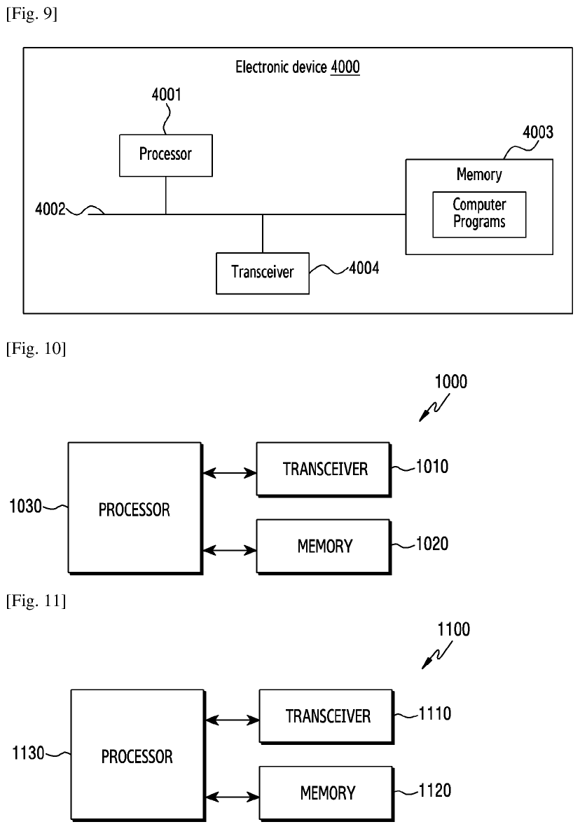

FIG. 9 shows a schematic structure diagram of an electronic device to which an embodiment of the present invention is applicable. As shown in FIG. 9, the electronic device 4000 in FIG. 9 includes a processor 4001 and a memory 4003. Wherein, the processor 4001 communicates with the memory 4003, e.g., via a bus 4002. Optionally, the electronic device 4000 may further include a transceiver 4004. The transceiver 4004 may be configured for data interaction between the electronic device and other electronic devices, for example, transmitting data and/or receiving data, etc. It is to be noted that, in practical applications, the number of the transceiver 4004 is not limited to one, and the structure of the electronic device 4000 does not constitute any limitation to the embodiments of the present disclosure. Optionally, the electronic device may be a first network node, a second network node or a third network node.

The processor 4001 may be a central processing unit (CPU), a general-purpose processor, a digital signal processor (DSP), an application specific integrated circuit (ASIC), a field programmable gate array (FPGA) or other programmable logic devices, a transistor logic device, a hardware component or any combination thereof. It is possible to implement or execute the various exemplary logical blocks, modules and circuits described in combination with the disclosures of the present disclosure. The processor 4001 may also be a combination for realizing computing functions, for example, a combination of one or more microprocessors, a combination of DSPs and microprocessors, etc.

The bus 4002 can include a path for delivering information among the above components. The bus 4002 may be a peripheral component interconnect (PCI) bus, an extended industry standard architecture (EISA) bus, etc. The bus 4002 may be classified into address bus, data bus, control bus, etc. For ease of illustration, only one bold line is shown in FIG. 9, but does not indicate that there is only one bus or type of bus.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store computer programs for executing embodiments of the present disclosure and is controlled for execution by the processor 4001. The processor 4001 is configured to execute the computer program stored in the memory 4003 to implement the steps shown in the foregoing method embodiment.

A method executed by a user equipment (UE) is provided. The method comprises receiving related information of a frequency-domain location of a first sub-band in a bandwidth part (BWP), receiving frequency-domain resource allocation information of a data channel in the first sub-band and determining the frequency-domain resource location of the data channel based on the related information of the frequency-domain location of the first sub-band and the frequency-domain resource allocation information of the data channel.

The receiving related information of a frequency-domain location of a first sub-band in a bandwidth part (BWP) comprises at least one of receiving a radio resource control (RRC) signaling or a medium access control (MAC) control element (CE) signaling, the RRC signaling or the MAC CE signaling containing frequency-domain location indication information of the first sub-band in the BWP; receiving an RRC signaling or an MAC CE signaling, the RRC signaling or the MAC CE signaling containing sub-band index indication information of the first sub-band in the BWP and receiving downlink control information (DCI), the DCI containing sub-band index indication information of the first sub-band in the BWP. The sub-band index indication information is used to indicate one sub-band from a plurality of sub-bands.

The frequency-domain location indication information of the first sub-band in the BWP contained in the RRC signaling or the MAC CE signaling is indicated based on a Type 0 resource allocation method or a Type 1 resource allocation method.

The plurality of sub-bands are obtained by dividing the BWP based on a predefined rule, or the plurality of sub-bands are configured based on an RRC signaling.

The plurality of sub-bands being preconfigured based on an RRC signaling comprises the plurality of sub-bands are configured based on the Type 0 resource allocation method or Type 1 resource allocation method through the RRC signaling.

The plurality of sub-bands being obtained by dividing the BWP based on a predefined rule comprises at least one of the plurality of sub-bands are obtained by dividing the BWP by a first division scheme, wherein physical resource blocks (PRBs) in the plurality of sub-bands are continuous, and the plurality of sub-bands are obtained by dividing the BWP by a second division scheme, wherein PRBs in the plurality of sub-bands are discrete.

The plurality of sub-bands being obtained by dividing the BWP by a first division scheme comprises at least one of the BWP is divided from a PRB with the lowest frequency domain using a division granularity of N PRBs to obtain └M/N┘ sub-bands and the BWP is divided from a PRB with the lowest frequency domain using a division granularity of 1 PRB to obtain M−N+1 sub-bands. M is the number of PRBs included in the BWP, N is the number N of PRBs included in the sub-band, and └M/N┘ represents that the M is divided by the N and then rounded down.

The BWP being divided from a PRB with the lowest frequency domain using a division granularity of N PRBs to obtain └M/N┘ sub-bands comprises if the M cannot be exactly divided by the N, the BWP is divided from a PRB with the lowest frequency domain using a division granularity of N PRBs to obtain └M/N┘ subbands, and then the BWP is divided from a PRB with the highest frequency domain using a division granularity of N PRBs to obtain other └M/N┘ sub-bands, so that total 2*└M/N┘ sub-bands are obtained.

The plurality of sub-bands being obtained by dividing the BWP by a second division scheme comprises PRBs in the BWP are allocated to different sub-bands one by one from a PRB with the lowest frequency domain to obtain └M/N┘ sub-bands. M is the number of PRBs included in the BWP, N is the number N of PRBs included in the subband, and └M/N┘ represents that the M is divided by the N and then rounded down.

The DCI and the data channel scheduled by the DCI satisfy a minimum gap in time, where the value of the minimum gap is predefined, or determined by the UE's capability and/or the resource earliest schedulable by the DCI is a first time unit after the DCI.

The method further comprises determining a second sub-band after frequency hopping based on the first sub-band, if the data channel is configured as a frequency hopping mode and receiving or transmitting, based on the first sub-band and the second sub-band, the data channel for frequency hopping transmission.

The determining a second sub-band after frequency hopping comprises at least one of determining the sub-band index of the second sub-band based on the sub-band index of the first sub-band, determining the second sub-band corresponding to the first sub-band based on an RRC signaling and determining the second sub-band corresponding to the first sub-band based on a DCI signaling.

The method further comprises monitoring a PDCCH for scheduling a broadcast physical downlink shared channel (PDSCH) by using a dedicated search space or a radio network temporary identity (RNTI) value dedicated to the UE, the dedicated search space being different from a search space used by a legacy system UE to monitor the PDCCH, or the dedicated RNTI value being different from an RNTI value used by a legacy system UE to monitor the PDCCH.

The method further comprises initiating a random access process on a dedicated physical random access channel (PRACH) resource, wherein the dedicated PRACH resource implicitly indicates to a base station that the UE is a second reduced capability (RedCap) UE.

The method further comprises initiating a random access process by using the dedicated PRACH resource for the second RedCap UE, if the dedicated PRACH resource is configured, initiating a random access process by using the dedicated PRACH resource for the first RedCap UE, if the dedicated PRACH resource for the second RedCap UE is not configured but the dedicated PRACH resource for the first RedCap UE is configured by the network and initiating a random access process by using a PRACH resource for a non-RedCap UE, if both the dedicated PRACH resource for the second RedCap UE and the dedicated PRACH resource for the first RedCap UE are not configured by the network.

The UE is prohibited from accessing a cell corresponding to the base station in any one of the following situations: the base station indicates, by using a reserved bit in a physical broadcast channel (PBCH), that the UE is prohibited from accessing the cell, the base station indicates, by using a reserved bit in DCI for scheduling a system information block (SIB1) PDSCH, that the UE is prohibited from accessing the cell, a PDSCH for carrying SIB1 is allocated with a bandwidth that exceeds a first preset bandwidth value and a PDSCH for carrying RAR is allocated with a bandwidth that exceeds the first preset bandwidth value.

The method further comprises reporting at least one of the following information to the base station: whether the UE has a capability to receive a unicast PDSCH and a PBCH simultaneously, where the unicast PDSCH and the PBCH are overlapped partially or completely in time resources, or located in the same time unit, and the total bandwidth of the bandwidth where the unicast PDSCH is located and the bandwidth where the PBCH is located does not exceed a third preset bandwidth value or exceeds the third preset bandwidth value, whether the UE has a capability to receive a unicast PDSCH and a broadcast PDSCH simultaneously, where the unicast PDSCH and the broadcast PDSCH are overlapped partially or completely in time resources, or located in the same time unit, and the total bandwidth of the bandwidth where the unicast PDSCH is located and the bandwidth where the broadcast PDSCH is located does not exceed the third preset bandwidth value or exceeds the third preset bandwidth value and whether the UE has a capability to receive at least two unicast PDSCHs simultaneously, where the at least two unicast PDSCHs are not overlapped in time resources, and located in the same time unit, and the total bandwidth of the bandwidths where the at least two unicast PDSCHs are located does not exceed the third preset bandwidth value or exceeds the third preset bandwidth value.

A method executed by a base station is provided. The method comprises transmitting, to a user equipment (UE), related information of a frequency-domain location of a first sub-band in a bandwidth part (BWP), transmitting a physical downlink control channel (PDCCH) to the UE, the PDCCH containing frequency-domain resource allocation information of a data channel in the first sub-band and transmitting the data channel scheduled by the PDCCH to the UE, the frequency-domain resource location of the data channel being determined based on the related information of the frequency-domain location of the first sub-band and the frequency-domain resource allocation information of the data channel.

A user equipment (UE) comprises a transceiver and a processor, which is coupled to the transceiver and configured to control to execute the steps of the method above described.

A base station comprises a transceiver; and a processor, which is coupled to the transceiver and configured to execute the steps of the method above described.

A method performed by a user equipment (UE) in a wireless communication system is provided. The method comprises receiving, from a base station, first information on a location of a first sub-band in a bandwidth part (BWP), receiving, from the base station, second information on at least one resource for a data channel in the first sub-band and identifying a location of the at least one resource for the data channel based on the first information and the second information.

The first information is received via at least one of a radio resource control (RRC) message, a medium access control (MAC) control element (CE), or downlink control information (DCI).

The method further comprises identifying a second sub-band after frequency hopping based on the first sub-band, in case that the data channel is configured as a frequency hopping mode and receiving, from the base station, the data channel for frequency hopping transmission based on the first sub-band and the second sub-band.

The method further comprises initiating a random access process on a dedicated physical random access channel (PRACH) resource. The dedicated PRACH resource indicates that the UE is a reduced capability (RedCap) UE.

A user equipment (UE) in a wireless communication system is provided. The UE comprises a transceiver and a controller coupled with the transceiver and configured to receive, from a base station, first information on a location of a first sub-band in a bandwidth part (BWP), receive, from the base station, second information on at least one resource for a data channel in the first sub-band, and identify a location of the at least one resource for the data channel based on the first information and the second information.

The first information is received via at least one of a radio resource control (RRC) message, a medium access control (MAC) control element (CE), or downlink control information (DCI).

The controller is further configured to identify a second sub-band after frequency hopping based on the first sub-band, in case that the data channel is configured as a frequency hopping mode, and receive, from the base station, the data channel for frequency hopping transmission based on the first sub-band and the second sub-band.

The controller is further configured to initiate a random access process on a dedicated physical random access channel (PRACH) resource. The dedicated PRACH resource indicates that the UE is a reduced capability (RedCap) UE.

A method performed by a base station in a wireless communication system is provided. The method comprises transmitting, to a user equipment (UE), first information on a location of a first sub-band in a bandwidth part (BWP); and transmitting, to the UE, second information on at least one resource for a data channel in the first sub-band. A location of the at least one resource for the data channel is associated with the first information and the second information.

The first information is transmitted via at least one of a radio resource control (RRC) message, a medium access control (MAC) control element (CE), or downlink control information (DCI).

The method further comprises transmitting, to the UE, a data channel for frequency hopping transmission based on the first sub-band and a second sub-band. The second sub-band is based on the first sub-band.

A random access process is based on a dedicated physical random access channel (PRACH) resource, and the dedicated PRACH resource indicates that the UE is a reduced capability (RedCap) UE.

A base station in a wireless communication system is provided. The base station comprises a transceiver; and a controller coupled with the transceiver and configured to transmit, to a user equipment (UE), first information on a location of a first sub-band in a bandwidth part (BWP), and transmit, to the UE, second information on at least one resource for a data channel in the first sub-band. A location of the at least one resource for the data channel is associated with the first information and the second information.

The first information is transmitted via at least one of a radio resource control (RRC) message, a medium access control (MAC) control element (CE), or downlink control information (DCI).

The controller is further configured to transmit, to the UE, a data channel for frequency hopping transmission based on the first sub-band and a second sub-band. The second sub-band is based on the first sub-band.

FIG. 10 illustrates a structure of a UE according to an embodiment of the disclosure.

As shown in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 10 corresponds to the UE of FIG. 1.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

FIG. 11 illustrates a structure of a base station according to an embodiment of the disclosure.

As shown in FIG. 11, the base station according to an embodiment may include a transceiver 1110, a memory 1120, and a processor 1130. The transceiver 1110, the memory 1120, and the processor 1130 of the base station may operate according to a communication method of the base station described above. However, the components of the base station are not limited thereto. For example, the base station may include more or fewer components than those described above. In addition, the processor 1130, the transceiver 1110, and the memory 1120 may be implemented as a single chip. Also, the processor 1130 may include at least one processor. Furthermore, the base station of FIG. 11 corresponds to base station of FIG. 1 to FIG. 10.

The transceiver 1110 collectively refers to a base station receiver and a base station transmitter, and may transmit/receive a signal to/from a terminal (UE) or a network entity. The signal transmitted or received to or from the terminal or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CDROM, and a DVD, or a combination of storage media.

The processor 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

Embodiments of the present disclosure provide a communication method, a user equipment and a base station, and relate to the technical field of wireless communication. The method comprises: receiving related information of a frequency-domain location of a first sub-band in a bandwidth part (BWP); receiving frequency-domain allocation information of a data channel in the first sub-band; and, determining the frequency-domain resource location of the data channel based on the related information of the frequency-domain location of the first sub-band and the frequency-domain resource allocation information of the data channel. By this solution, the bandwidth of the data channel can be allowed to not the baseband processing bandwidth of the UE, and the sub-bands for the data channel can be dynamically allocated within a bandwidth range of the BWP, that is, the data channel can be dynamically scheduled within a larger bandwidth range, thereby obtaining a selective diversity gain.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

The terms “first”, “second”, “third”, “fourth”, “1”, “2”, etc. (if any) in the specification and claims of the present disclosure and the accompanying drawings are used for distinguishing similar objects, rather than describing a particular order or precedence. It should be understood that the used data can be interchanged if appropriate, so that the embodiments of the present invention described herein can be implemented in an order other than the orders illustrated or described with text.

It should be understood that, although various operational steps are indicated by arrows in the flowcharts of embodiments of the present disclosure, the order in which the steps are performed is not limited to the order indicated by the arrows. Unless explicitly stated herein, in some implementation scenarios of embodiments of the present disclosure, the implementation steps in the respective flowcharts may be performed in other order as required. In addition, some or all of the steps in each flowchart may include multiple sub-steps or multiple stages based on actual implementation scenarios. Some or all of these sub-steps or phases may be executed at the same moment, and each of these sub-steps or phases may also be executed separately at different moments. The order of execution of these sub-steps or stages can be flexibly configured according to requirements in different scenarios of execution time, and the embodiments of the present disclosure are not limited thereto.

The text and drawings are provided as examples only to help readers understand the present disclosure. They are not intended and should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure. Other similar implementation means based on the technical idea of the present disclosure are adopted, and likewise belong to the protection scope of the embodiments of the present disclosure.

1. A method performed by a user equipment (UE) in a wireless communication system, the method comprising:
receiving, from a base station, first information on a location of a first sub-band in a bandwidth part (BWP);
receiving, from the base station, second information on at least one resource for a data channel in the first sub-band; and
identifying a location of the at least one resource for the data channel based on the first information and the second information.

2. The method of claim 1, wherein the first information is received via at least one of a radio resource control (RRC) message, a medium access control (MAC) control element (CE), or downlink control information (DCI).

3. The method of claim 1, further comprising:
identifying a second sub-band after frequency hopping based on the first sub-band, in case that the data channel is configured as a frequency hopping mode; and
receiving, from the base station, the data channel for frequency hopping transmission based on the first sub-band and the second sub-band.

4. The method of claim 1, further comprising:
initiating a random access process on a dedicated physical random access channel (PRACH) resource,
wherein the dedicated PRACH resource indicates that the UE is a reduced capability (RedCap) UE.

5. A user equipment (UE) in a wireless communication system, the UE comprising:
a transceiver; and
a controller coupled with the transceiver and configured to:
receive, from a base station, first information on a location of a first sub-band in a bandwidth part (BWP),
receive, from the base station, second information on at least one resource for a data channel in the first sub-band, and
identify a location of the at least one resource for the data channel based on the first information and the second information.

6. The UE of claim 5, wherein the first information is received via at least one of a radio resource control (RRC) message, a medium access control (MAC) control element (CE), or downlink control information (DCI).

7. The UE of claim 5, wherein the controller is further configured to:
identify a second sub-band after frequency hopping based on the first sub-band, in case that the data channel is configured as a frequency hopping mode, and
receive, from the base station, the data channel for frequency hopping transmission based on the first sub-band and the second sub-band.

8. The UE of claim 5, wherein the controller is further configured to:
initiate a random access process on a dedicated physical random access channel (PRACH) resource,
8, wherein the dedicated PRACH resource indicates that the UE is a reduced capability (RedCap) UE.

9. A method performed by a base station in a wireless communication system, the method comprising:
transmitting, to a user equipment (UE), first information on a location of a first sub-band in a bandwidth part (BWP); and
transmitting, to the UE, second information on at least one resource for a data channel in the first sub-band,
wherein a location of the at least one resource for the data channel is associated with the first information and the second information.

10. The method of claim 9, wherein the first information is transmitted via at least one of a radio resource control (RRC) message, a medium access control (MAC) control element (CE), or downlink control information (DCI).

11. The method of claim 9, further comprising:
transmitting, to the UE, a data channel for frequency hopping transmission based on the first sub-band and a second sub-band,
wherein the second sub-band is based on the first sub-band.

12. The method of claim 9, wherein a random access process is based on a dedicated physical random access channel (PRACH) resource, and wherein the dedicated PRACH resource indicates that the UE is a reduced capability (RedCap) UE.

13. A base station in a wireless communication system, the base station comprising:
a transceiver; and
a controller coupled with the transceiver and configured to:
transmit, to a user equipment (UE), first information on a location of a first sub-band in a bandwidth part (BWP), and
transmit, to the UE, second information on at least one resource for a data channel in the first sub-band,
wherein a location of the at least one resource for the data channel is associated with the first information and the second information.

14. The base station of claim 13, wherein the first information is transmitted via at least one of a radio resource control (RRC) message, a medium access control (MAC) control element (CE), or downlink control information (DCI).

15. The base station of claim 13, wherein the controller is further configured to:
transmit, to the UE, a data channel for frequency hopping transmission based on the first sub-band and a second sub-band, and
wherein the second sub-band is based on the first sub-band.
